(19) United States
(12) Patent Application Publication
(10) Pub. No.: US 2026/0253055 A1
(43) Pub. Date: Aug. 27, 2026

(54) 24HWS_BEI_Systemic 999 Infrastructure for Sovereign Terminal Platform

(71) Applicant: FURONG BEI, SAN GABRIEL, CA (US)

(72) Inventor: FURONG BEI, SAN GABRIEL, CA (US)

(21) Appl. No.: 19/177,665

(22) Filed: Apr. 14, 2025

(51) Int. Cl. G06Q 20/32; G06Q 20/40

(52) U.S. Cl. CPC G06Q 20/3229; G06Q 20/401

(57) ABSTRACT

A domain-resolved ReadName Token Terminal infrastructure generates a terminal endpoint from identity, system, demand, time-window, and nonce inputs and binds the endpoint to a behavioral-economic identity (BEI) anchor, terminal reference, communication endpoint, wallet endpoint, clearing endpoint, access registry, lifecycle state, and receipt reference. A switchless communication module routes messages or sessions using domain-linked sender and recipient references, behavioral context, verification fields, nonces, and validity windows without requiring a telephone number, SIM credential, or switch code as a controlling endpoint. A SIM-free authentication module validates terminal operations using domain keypairs, time signatures, behavior-time proofs, and terminal state. A wallet and clearing module authorizes payments or settlements using domain-linked credentials and machine-verifiable receipts. Cross-domain synchronization, risk isolation, lifecycle control, optional hardware attestation, metadata locking, bounded-correction interfaces, and index-output modules update BEI credential, terminal, transaction, revocation, receipt, licensing, marketplace, audit, compliance, and synchronization states across interoperable platforms.

### CROSS-REFERENCE TO RELATED APPLICATIONS

This substitute specification is submitted for the above-identified application to place the disclosure in a clearer, more continuous, and more technically organized form. The disclosure is directed to the same domain-resolved sovereign terminal infrastructure originally presented, including ReadName or second-level domain terminal references, domain-token terminal credentials, switchless communication, SIM-free identity, behavior-time authentication, wallet and clearing functions, terminal access, domain-based routing, and related lifecycle and receipt operations.

### TECHNICAL FIELD

The present disclosure relates to computer-implemented domain-resolved terminal infrastructures, behavioral-economic identity, privacy-preserving terminal authentication, switchless communication routing, wallet clearing, and interoperable terminal access control.

More particularly, the disclosure relates to a ReadName Token Terminal infrastructure in which a domain-linked terminal endpoint is generated, bound to an identity anchor, authenticated through behavior-time and terminal-state proofs, and used as an interface for communication, navigation, wallet settlement, access control, receipts, lifecycle management, and interoperable asset outputs.

The disclosed embodiments may be implemented using one or more processors, server nodes, user terminals, mobile devices, browser terminals, trusted devices, edge nodes, domain resolvers, wallet services, distributed ledgers, append-only logs, databases, smart-contract logic, application programming interfaces, or combinations thereof. The invention is not limited to a particular blockchain, domain registrar, SIM carrier, mobile operating system, wallet implementation, or payment rail.

### BACKGROUND

Conventional communication systems rely heavily on telephone numbers, SIM credentials, switch codes, platform accounts, or carrier-controlled routing handles. Such identifiers may be useful for voice or data service, but they are not designed to operate as a combined identity anchor, wallet endpoint, terminal credential, behavioral proof endpoint, access-right registry, and settlement receipt source.

Conventional payment systems may use bank routing numbers, card rails, wallet addresses, static QR codes, platform handles, or one-time payment links. These mechanisms generally do not bind the payment request to a domain-resolved terminal endpoint, a behavior-time proof, a terminal lifecycle state, a cross-domain credential state, and a machine-verifiable receipt that can be reused for later communication, access, audit, licensing, or index updates.

Conventional navigation systems may use GPS coordinates, physical addresses, static maps, or platform search indexes. Those systems generally do not treat a behavior-linked identity, domain endpoint, terminal state, route confidence, wallet status, and access-right status as a common machine-readable routing fabric.

Decentralized identity, non-fungible token, domain naming, and wallet systems have introduced useful naming and asset concepts. However, a domain name, wallet address, token identifier, or decentralized identifier often remains separated from terminal authentication, behavior-time routing, access-right control, risk isolation, lifecycle revocation, cross-domain synchronization, and settlement receipt generation.

There remains a need for a technical infrastructure in which a human-readable or domain-linked terminal reference can operate as a network endpoint, identity anchor, communication routing address, wallet and clearing endpoint, access-control object, receipt source, and index-updating terminal state. Such infrastructure should define concrete records, fields, state transitions, receipts, failure modes, and interoperable outputs so that it can be implemented and audited as a computer-network invention rather than as an abstract business arrangement.

### SUMMARY

In one aspect, a domain-resolved ReadName Token Terminal infrastructure generates a terminal endpoint from identity, system, demand, time-window, and nonce inputs. The endpoint may be represented by a ReadName, a second-level domain reference, a domain-linked terminal credential, a tokenized terminal record, or an equivalent canonical endpoint reference.

In another aspect, a Dynamic Domain Generation Engine receives inputs including an identity reference, a system reference, a demand or context type, a timestamp or trusted time window, and a nonce or random seed. The engine outputs a domain-resolved terminal endpoint and may perform collision detection, policy-version assignment, lifecycle-state assignment, and receipt generation.

In another aspect, a ReadName Token Terminal endpoint record binds a domain reference to an identity anchor, a terminal reference, a communication endpoint, a wallet endpoint, a clearing endpoint, an access registry reference, a policy version, a lifecycle state, and a receipt reference. The record may be resolved through a domain-talking index or endpoint resolver.

In another aspect, a switchless communication module routes message packages or sessions using domain-linked sender and recipient references, behavioral context fields, verification fields, nonces, and validity windows without requiring a telephone number, SIM credential, or switch code as a controlling endpoint.

In another aspect, a SIM-free terminal authentication module validates terminal operations using a domain keypair, time signature, terminal identifier, behavior-time proof, validity window, nonce, and optional hardware attestation. Hardware attestation may include a physical unclonable function, trusted execution environment, measured boot verification, root-key derivation, and remote attestation in higher-security embodiments.

In another aspect, a behavior-time routing module uses behavior density, time continuity, interaction diversity, domain context, relationship state, route confidence, and policy state to resolve communication, navigation, payment, or terminal-access requests. GPS may be used as an optional input, but is not required as the sole controlling source of route context.

In another aspect, a wallet, banking, payment, or clearing endpoint authorizes payment or settlement operations using domain-linked credentials and machine-verifiable receipts. A payment request may be authorized by a behavior-time proof and domain credential instead of, or in addition to, a static QR identifier.

In another aspect, cross-domain synchronization and mapping modules synchronize identity, credential, terminal, transaction, revocation, receipt, and index states across domain systems. A terminal access registry enables, limits, suspends, revokes, or requests re-verification of identity, communication, navigation, wallet, marketplace, governance, and audit modules.

In another aspect, machine-verifiable receipts, event metadata locks, bounded-correction interfaces, risk-isolation signals, lifecycle records, and index-output records update terminal, credential, transaction, revocation, licensing, marketplace, and audit states. These outputs support interoperable asset packages without requiring the ReadName Token Terminal infrastructure to be limited to any single marketplace, blockchain, or resource registry.

### DEFINITIONS

As used herein, “ReadName Token Terminal or RTT” means a domain-resolved terminal endpoint that can operate as an identity endpoint, communication endpoint, wallet endpoint, clearing endpoint, access-control endpoint, receipt source, or index-updating terminal state.

As used herein, “ReadName” means a human-readable or machine-resolvable domain-linked reference associated with a terminal endpoint, which may include a second-level domain, subdomain, URI, hash, tokenized record, or canonical endpoint identifier.

As used herein, “Domain Token Terminal Credential” means a tokenized, signed, or otherwise machine-verifiable credential that binds a domain reference to a terminal, identity anchor, lifecycle state, or endpoint record.

As used herein, “Dynamic Domain Generation Engine or DGE” means a module that generates or selects a domain-resolved terminal endpoint from identity, system, demand, time, nonce, policy, or context inputs.

As used herein, “Domain-Resolved Endpoint Record” means a structured record mapping a domain reference to identity, terminal, communication, wallet, clearing, access, policy, lifecycle, and receipt fields.

As used herein, “Identity Anchor” means a BEI-ID, behavioral-economic identity reference, credential reference, ledger pointer, domain-talking reference, public key, hash, or other canonical identity state.

As used herein, “Switchless Communication Route” means a communication route that does not require a telephone number, SIM credential, or switch code as the controlling endpoint, and instead uses a domain-linked reference with verification state.

As used herein, “SIM-Free Terminal Authentication” means terminal authentication based on domain keys, terminal identifiers, time signatures, behavior-time proofs, nonces, validity windows, or optional hardware attestation rather than a SIM credential as the controlling identity source.

As used herein, “TransferKey or Authorization SDK” means software, firmware, or an API library configured to sign, authorize, verify, or package identity, communication, payment, navigation, minting, access, revocation, or settlement operations.

As used herein, “Behavior-Time Proof” means a proof, signature, commitment, credential, or verification result derived from behavioral context and a trusted time field or time window.

As used herein, “Time-Domain Reference” means a time-related domain, temporal category, trusted time window, policy window, session window, settlement window, correction window, timestamp, or ledger time used for ordering, eligibility, or audit.

As used herein, “Time-Asset Record” means a structured record that binds a terminal event or behavior event to a time-domain reference and can support eligibility, service credit, receipt, settlement, audit, or index output.

As used herein, “Cross-Domain Synchronization Channel” means a machine-readable channel or protocol for synchronizing identity, credential, terminal, transaction, revocation, receipt, access, or index state across domain systems.

As used herein, “Terminal Access Registry” means a registry controlling terminal modules or functions using module identifiers, access states, policy versions, validity windows, reason codes, and receipt references.

As used herein, “Machine-Verifiable Receipt” means a structured output record identifying an event type, endpoint reference, identity anchor, policy version, verification result, prior state, new state, evidence commitment, status, and signature or ledger reference.

As used herein, “Lifecycle State” means a terminal, credential, or identity state including initialized, active, limited, suspended, revoked, expired, inherited, transferred, recovered, disputed, quarantined, or re-verification-required.

As used herein, “Risk Isolation Signal” means an output that limits, quarantines, suspends, redirects, or requires re-verification of a terminal, route, credential, transaction, or access request in response to abnormal or invalid conditions.

As used herein, “Event Metadata Lock” means a signed or committed event record that locks event metadata such as event type, endpoint, time, nonce, policy version, evidence commitment, and receipt status.

As used herein, “Interoperable Asset Output” means a licensing package, transfer package, marketplace listing, audit record, asset package, valuation metadata, or index update generated from terminal or receipt state.

As used herein, “Hardware-Attested Terminal” means an optional terminal embodiment using a PUF, TEE, measured boot, root-key derivation, secure storage, or remote attestation to strengthen terminal trust.

### BRIEF DESCRIPTION OF THE DRAWINGS

FIG. 1 illustrates an overall domain-resolved ReadName Token Terminal infrastructure.

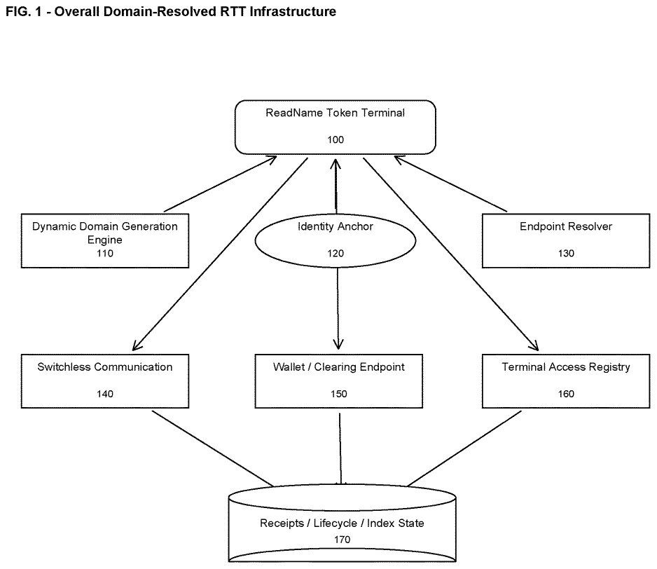

FIG. 2 illustrates a domain namespace backbone and optional plural domain categories.

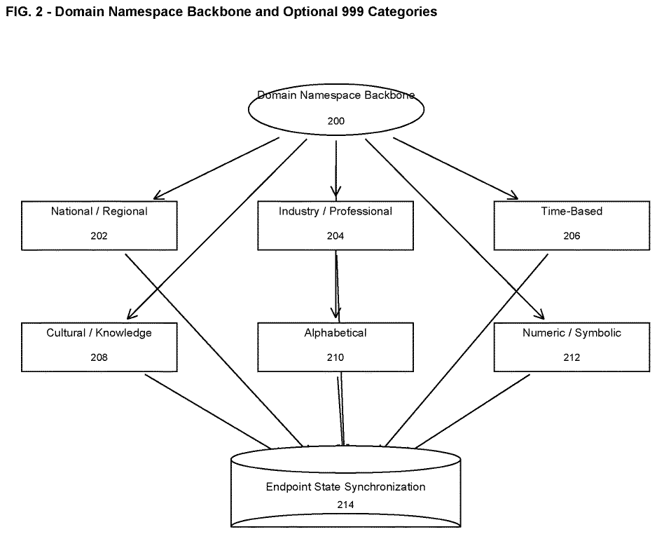

FIG. 3 illustrates a Dynamic Domain Generation Engine.

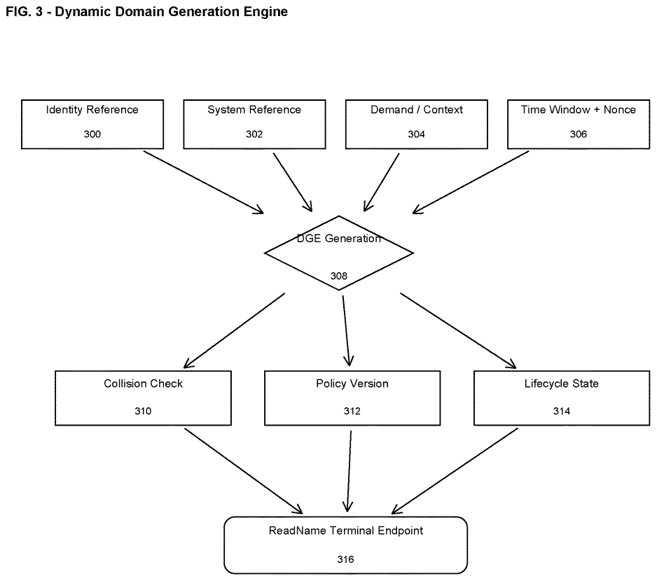

FIG. 4 illustrates a ReadName Token Terminal endpoint record.

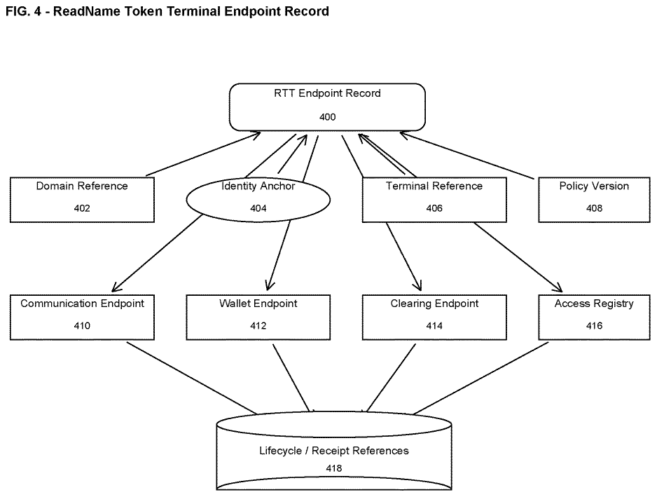

FIG. 5 illustrates a domain-talking or endpoint resolver.

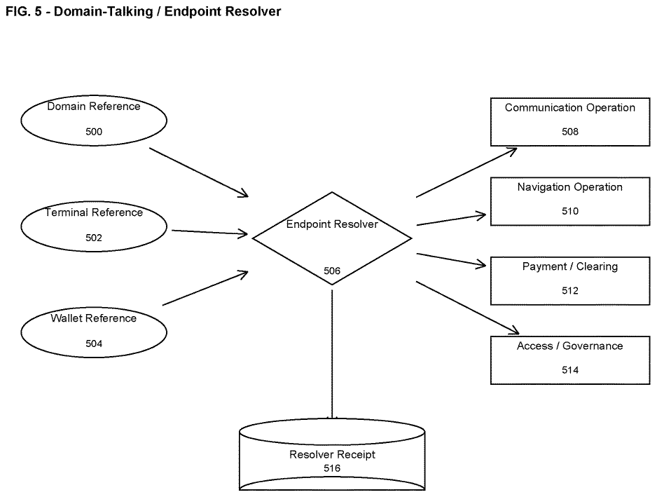

FIG. 6 illustrates switchless communication routing.

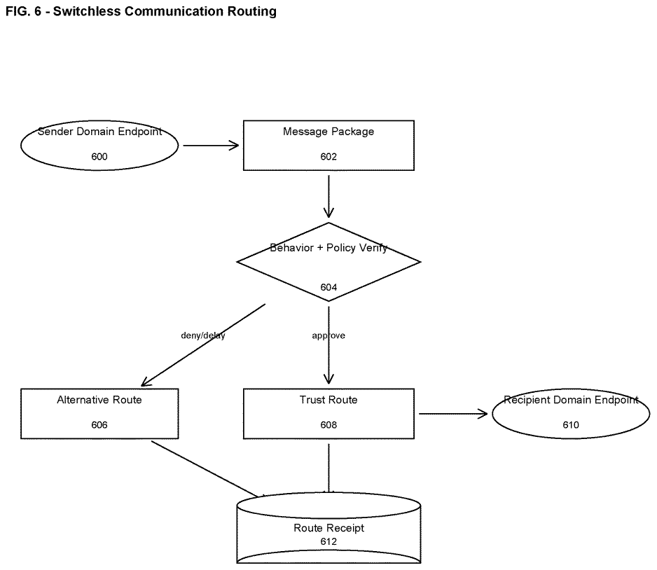

FIG. 7 illustrates SIM-free terminal authentication.

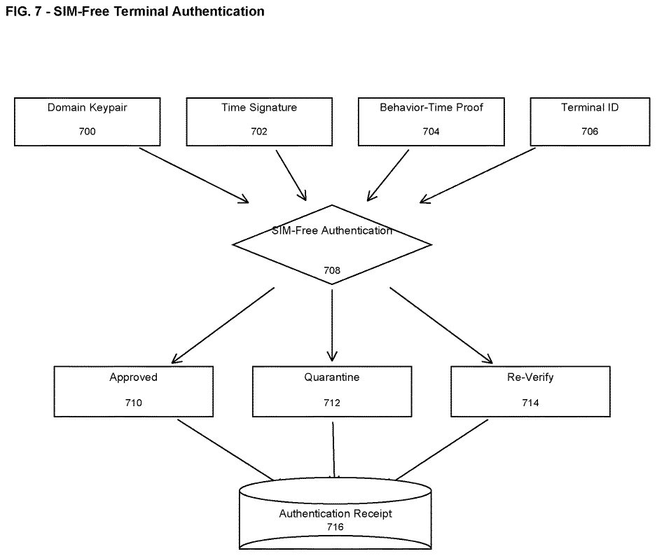

FIG. 8 illustrates a TransferKey or authorization SDK embodiment.

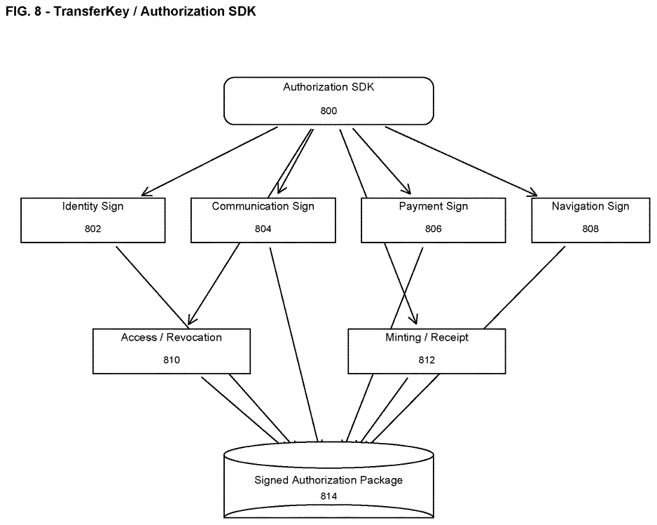

FIG. 9 illustrates behavior-time navigation and route context.

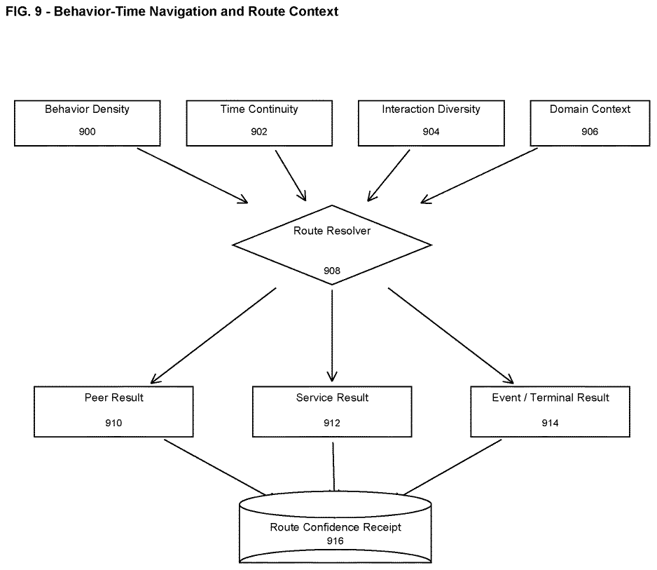

FIG. 10 illustrates a time-domain recorder and time-asset binding process.

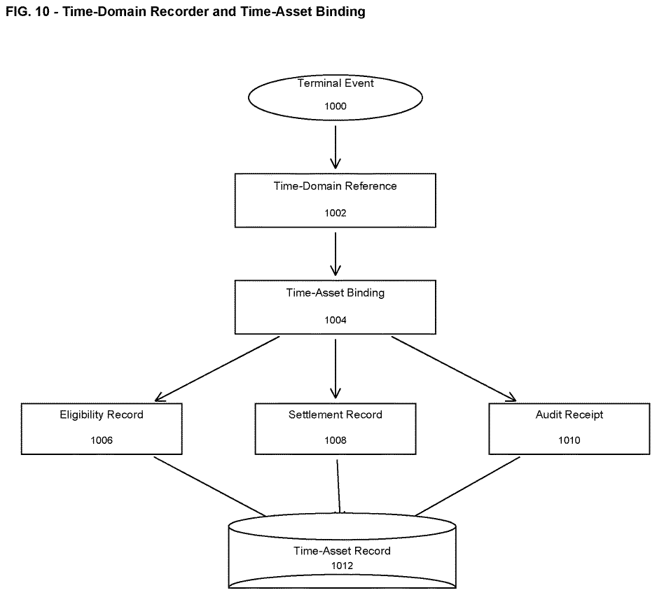

FIG. 11 illustrates a wallet, banking, payment, and clearing endpoint.

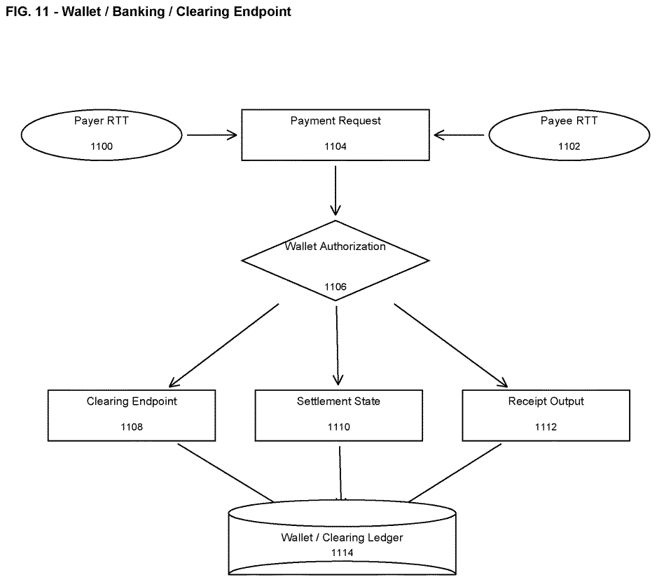

FIG. 12 illustrates a QR replacement payment handshake.

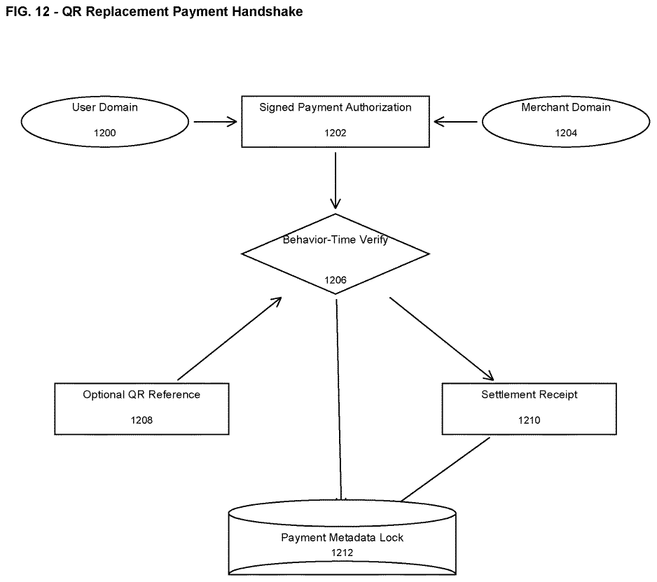

FIG. 13 illustrates identity lifecycle and revocation control.

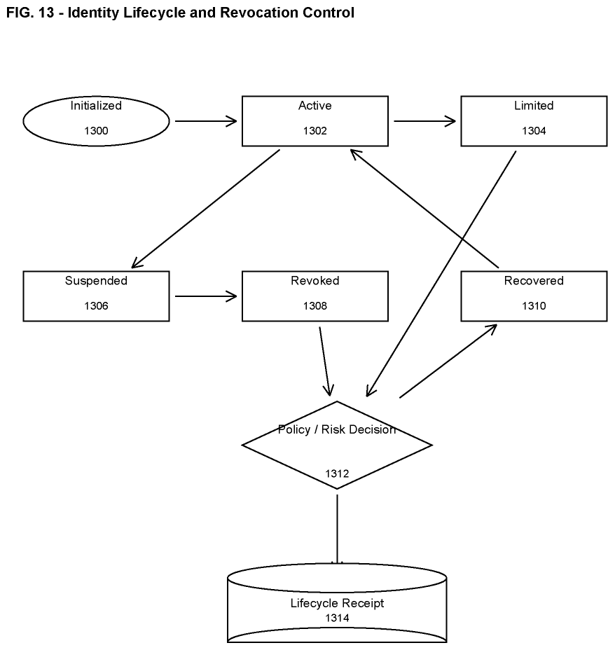

FIG. 14 illustrates cross-domain synchronization channels.

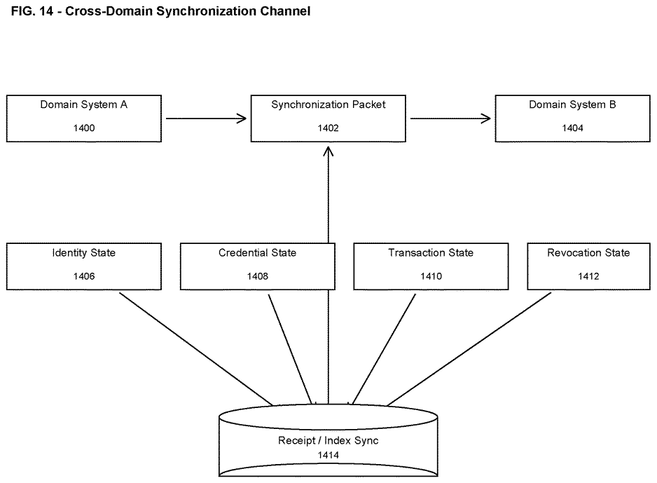

FIG. 15 illustrates a cross-domain mapping module.

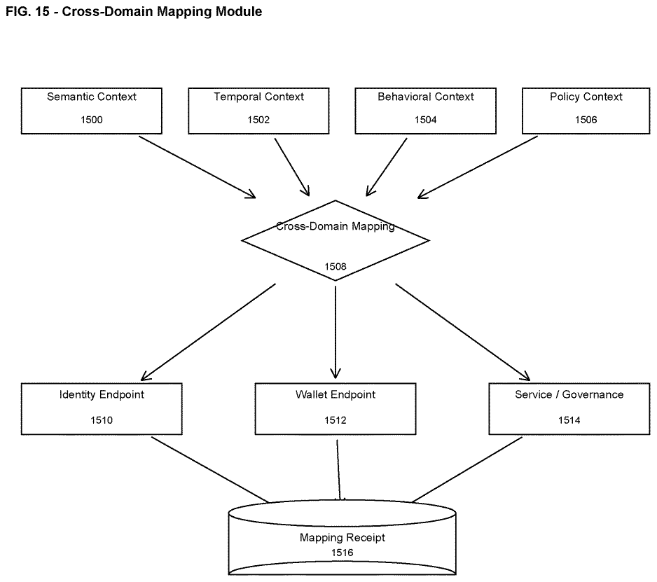

FIG. 16 illustrates a terminal access registry.

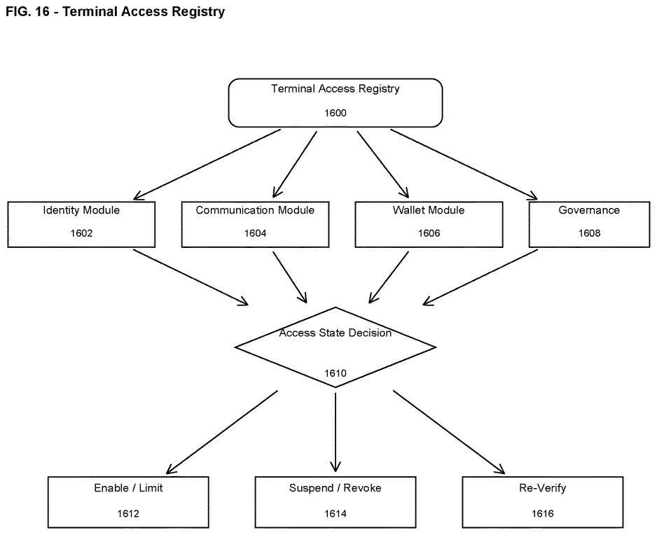

FIG. 17 illustrates behavior, biometric, and sensor proof commitments.

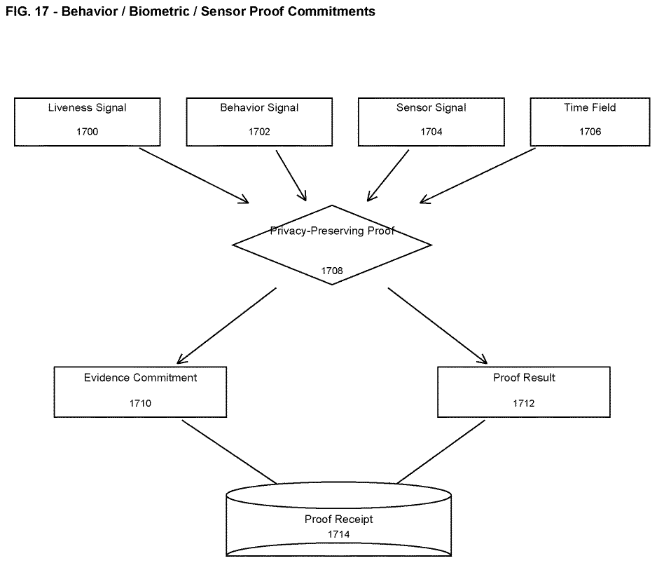

FIG. 18 illustrates an optional hardware-attested RTT terminal.

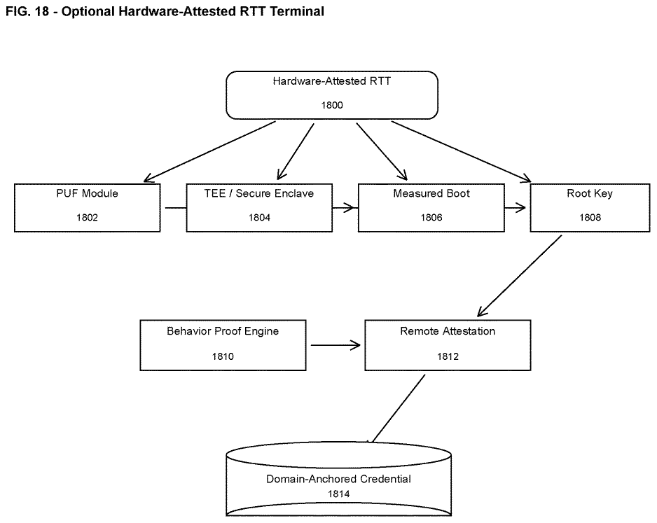

FIG. 19 illustrates an event metadata lock and machine-verifiable receipt.

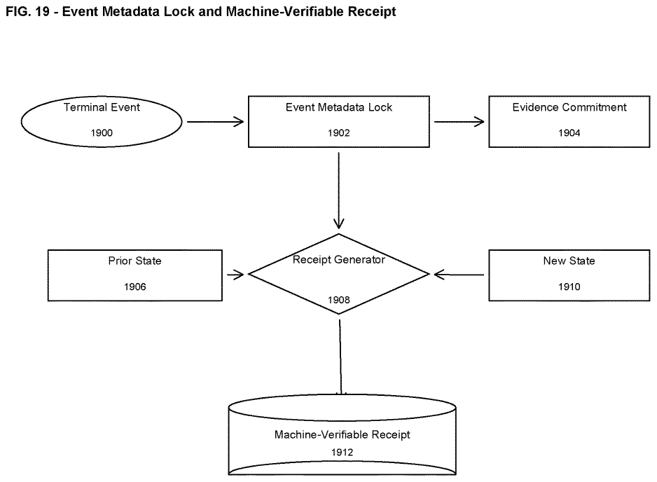

FIG. 20 illustrates risk isolation, bounded correction, and finality interfaces.

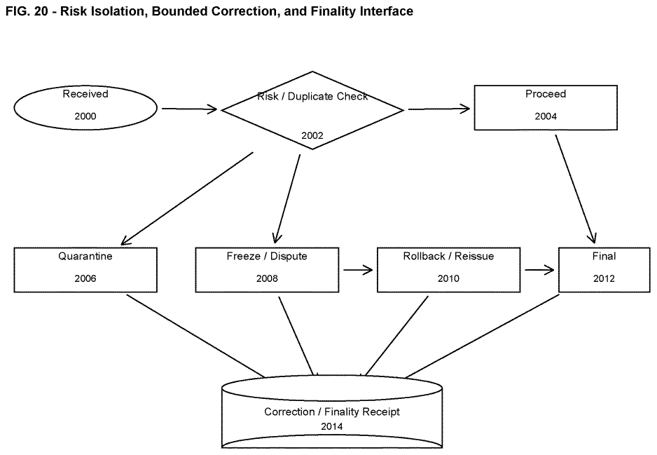

FIG. 21 illustrates interoperable asset, licensing, marketplace, and index outputs.

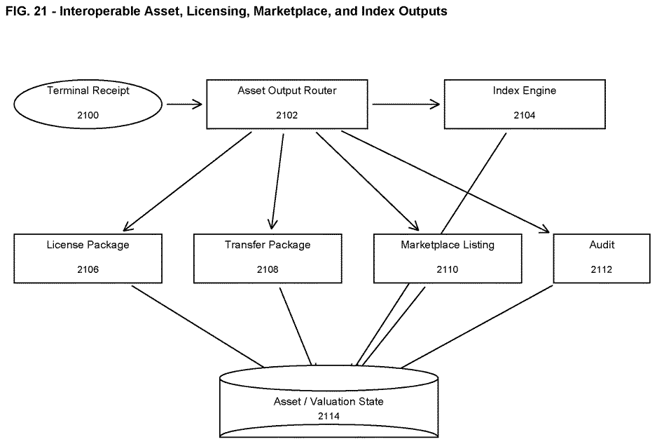

FIG. 22 illustrates an end-to-end RTT operation lifecycle.

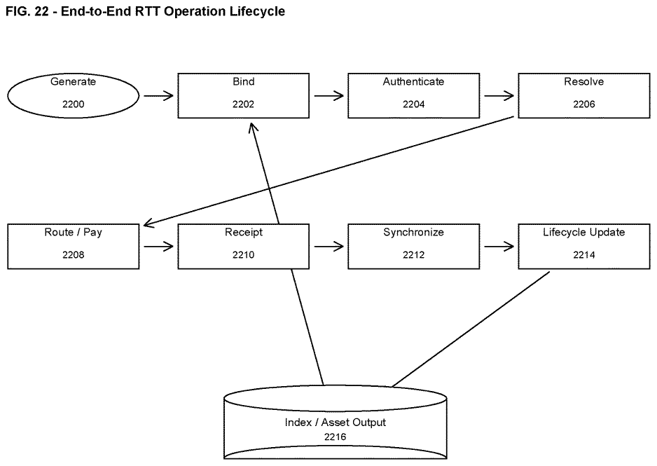

### DETAILED DESCRIPTION

### Overall RTT Sovereign Terminal Infrastructure

The infrastructure includes a domain namespace backbone, a Dynamic Domain Generation Engine, a ReadName Token Terminal endpoint record, an identity-anchor verifier, a domain-talking endpoint resolver, a switchless communication module, a SIM-free terminal authentication module, a behavior-time routing module, a wallet and clearing endpoint module, a terminal access registry, and output modules for receipts, lifecycle state, risk isolation, index updates, and interoperable asset records.

The modules may be executed on one server, multiple servers, user terminals, web terminals, edge nodes, trusted devices, cloud services, distributed ledger nodes, or combinations thereof. A module may be implemented as software instructions, smart-contract logic, firmware, secure enclave code, an API service, database logic, or a peer-to-peer node operation.

An operation typically begins when a user, terminal, device, service, wallet, marketplace, governance module, or external platform submits a request referencing a ReadName, domain endpoint, identity anchor, terminal identifier, or other endpoint reference. The request is canonicalized, verified against policy and state records, and then routed to communication, navigation, payment, access, lifecycle, or receipt-processing logic.

The technical significance of the infrastructure is that the domain-resolved terminal endpoint is not merely a label. It becomes a stateful object used by multiple modules. Each module consumes or emits structured records that can be validated, written to a ledger or database, and used by later operations. This shared record fabric reduces fragmentation between identity, communication, wallet, navigation, access control, and settlement systems.

### Domain Namespace Backbone and Optional 999 Architecture

The domain namespace backbone may include a plurality of domain systems. In some embodiments, the plurality includes policy-defined categories such as national or regional domains, industry or professional domains, time-based domains, cultural or knowledge domains, alphabetical domains, and numerical or symbolic domains. A deployment may include 999 domain-based systems or another policy-defined number of systems.

Each domain system may generate, register, or map secondary, tertiary, or deeper endpoint references. A second-level or subdomain reference may serve as a ReadName, domain-talking reference, terminal endpoint, service endpoint, wallet endpoint, identity endpoint, or marketplace endpoint. The domain system is not limited to public DNS and may include private namespaces, application namespaces, ledger namespaces, URIs, hashes, or signed endpoint records.

A domain namespace backbone may support interoperability by synchronizing endpoint records, credential states, terminal states, revocation states, transaction states, and receipt states across systems. The same user or terminal may therefore be resolved differently for communication, wallet settlement, access control, and governance while preserving a common identity anchor or credential reference.

The architecture may be deployed incrementally. A first deployment may support a small group of domains and endpoints. A second deployment may add time-domain references. A third deployment may add wallet and marketplace endpoints. A fourth deployment may add cross-domain synchronization and hardware-attested terminal credentials. The claim elements are not dependent on a fixed number of domains.

### Dynamic Domain Generation Engine

The Dynamic Domain Generation Engine receives input fields including a user reference, identity anchor, system reference, demand type, context type, timestamp, trusted time window, nonce, random seed, policy version, domain category, terminal category, or jurisdiction field. A non-limiting generation expression may be D=H(UserID, SystemID, DemandType, Timestamp, RandomSeed), where H is a cryptographic hash or other deterministic or probabilistic generation function.

The engine outputs a ReadName, second-level domain reference, canonical endpoint identifier, tokenized terminal record, or equivalent terminal reference. The output may include a collision status, uniqueness proof, policy version, lifecycle state, endpoint record pointer, and machine-verifiable receipt.

The engine may check whether a generated ReadName conflicts with an existing endpoint, expired endpoint, reserved endpoint, revoked endpoint, disputed endpoint, inherited endpoint, or transferred endpoint. If a conflict occurs, the engine may generate an alternate endpoint, assign a pending status, request governance review, or issue a dispute receipt.

The DGE may also bind the generated endpoint to a domain-token terminal credential. In such an embodiment, the credential may be implemented as an NFT, signed metadata object, ledger event, database record, certificate, or other machine-verifiable record. The credential need not be limited to a public blockchain token.

### ReadName Token Terminal Endpoint Record

A ReadName Token Terminal endpoint record may include fields such as rtt_id, ReadName, domain_reference, identity_anchor, terminal_reference, communication_endpoint, wallet_endpoint, clearing_endpoint, access_registry_reference, policy_version, lifecycle_state, validity_window, revocation_state, evidence_commitment, and receipt_reference.

The endpoint record may be signed, hashed, stored in a database, stored in an append-only log, represented by a token metadata record, or anchored in a distributed ledger. The record may include a payload reference rather than raw private data so that private credentials, sensor data, or wallet keys need not be publicly disclosed.

The endpoint record can be updated through lifecycle operations. For example, a record may move from initialized to active after identity verification, from active to limited after risk isolation, from limited to recovered after re-verification, from active to transferred after a transfer event, or from active to revoked after credential compromise.

The record may include multiple endpoint roles. A communication endpoint may route messages, voice, video, or service signals. A wallet endpoint may authorize payment or settlement. A clearing endpoint may generate receipts. An access registry endpoint may determine module availability. An audit endpoint may expose proof results or receipts to authorized parties.

### Domain-Talking and Endpoint Resolver

The endpoint resolver maps domain-linked references, terminal references, identity anchors, wallet references, service endpoints, marketplace records, governance endpoints, and audit endpoints to machine-readable operations. A resolver response may include endpoint type, canonical identifier, identity anchor, policy version, validity window, route status, revocation state, and receipt reference.

A human-facing ReadName or domain-talking reference may be resolved to a canonical BEI-ID, terminal endpoint, message endpoint, wallet endpoint, service endpoint, marketplace listing, governance endpoint, or asset record. The same ReadName may support different scopes while preserving separate privacy and access states.

The resolver may evaluate semantic context, temporal context, behavioral context, geographic or route context, category context, policy context, or jurisdiction context. For example, a ReadName used in a medical context may resolve to a healthcare credential endpoint, while the same or related ReadName used in a payment context may resolve to a wallet endpoint.

Resolver outputs may be cached by terminals or edge nodes. A cached output may include expiration, revocation, and synchronization fields. A later cross-domain synchronization update may invalidate the cache or require re-verification before a transaction or communication operation proceeds.

### Switchless Communication Layer

The switchless communication module routes communication using domain-linked sender and recipient references rather than requiring a telephone number, SIM credential, or switch code as the controlling endpoint. A route may still interoperate with conventional communication networks, but the controlling identity and route decision may be based on the ReadName endpoint record and verification state.

A communication request may include sender_endpoint, recipient_endpoint, behavioral_context, relationship_context, routing_field, verification_field, nonce, validity_window, payload_reference, privacy_flag, policy_version, and receipt_reference. The module may canonicalize the request before verification so that routing nodes evaluate a consistent representation.

The module may support text, voice, video, asynchronous messages, service signals, credential signals, wallet signals, marketplace signals, governance notices, or terminal-access notifications. Each operation may generate a route receipt or denial receipt that can later update relationship state, trust state, access state, or risk state.

A message may be routed, denied, delayed, quarantined, redirected, or marked re-verification-required. These failure modes distinguish the system from generic messaging because routing depends on identity anchor, terminal state, behavioral context, nonce, validity window, policy version, and access-right state.

### SIM-Free Terminal Authentication

The SIM-free terminal authentication module validates terminal operations using terminal identifiers, domain keypairs, time signatures, behavior-time proofs, nonces, validity windows, policy versions, and optional device-state records. A SIM credential may be present for network access but is not required as the controlling credential for the terminal operation.

A terminal authentication record may include terminal_id, domain_reference, public_key_reference, time_signature, behavior_proof_reference, session_state, nonce, validity_window, policy_version, revocation_state, and receipt_reference. A verifier may approve, reject, quarantine, or request re-verification according to these fields.

The module may support multi-factor operation. For example, a domain keypair may prove endpoint control, a behavior-time proof may prove user or terminal context, a nonce may prevent replay, and a lifecycle state may determine whether the endpoint is active, limited, suspended, or revoked.

The module may interoperate with hardware-attested terminal credentials. In such embodiments, a PUF-derived root key, trusted execution environment, measured-boot report, secure enclave quote, or remote attestation report may strengthen terminal trust. The broader authentication architecture does not require a specific hardware security technology.

### TransferKey or Authorization SDK Embodiments

A TransferKey or equivalent authorization SDK may provide a cross-platform library for signing, verifying, packaging, or authorizing operations. The SDK may be implemented for web, mobile, server, browser, IoT, wallet, terminal, or edge-node environments.

The SDK may sign identity initialization requests, communication route requests, payment authorization requests, navigation intents, minting or credential issuance requests, terminal access requests, revocation requests, lifecycle updates, and receipt retrieval requests.

An SDK output may include operation_type, domain_reference, identity_anchor, terminal_reference, policy_version, nonce, validity_window, signature_reference, proof_reference, and receipt_status. The output may be consumed by the endpoint resolver, communication module, wallet module, access registry, lifecycle controller, or risk-isolation module.

The authorization SDK may rotate keys, maintain a keyring, support domain-scoped keys, support emergency key revocation, and separate keys by operation type. For example, a communication key may not authorize a wallet transfer unless a policy explicitly permits cross-scope signing.

### Behavior-Time Routing and Navigation

Behavior-time routing may use behavior density, time continuity, interaction diversity, route confidence, domain node context, relationship state, relevance state, and policy state to resolve endpoints. The routing context may supplement or replace GPS as the controlling route source.

A navigation or route request may include an intent signal, identity anchor, terminal reference, time window, behavior presence value, relationship graph reference, trust value, relevance value, domain context, route confidence, and policy version. The resolver may output a peer endpoint, service endpoint, event endpoint, marketplace endpoint, terminal endpoint, or denial reason.

In a GPS-free embodiment, location or movement context may be inferred from behavior-time signatures, interaction history, domain node proximity, service context, or validated route events. In a GPS-supplemented embodiment, GPS may be included as one input but not as the sole controlling source.

Navigation results may be written back as machine-verifiable receipts. A successful route may increase route confidence or trust. A rejected route may trigger access limitation or re-verification. A disputed route may enter a correction or finality interface.

### Time-Domain Recorder and Time-Asset Binding

A time-domain recorder may bind terminal events to time-domain references such as session, minute, hour, day, week, month, year, policy window, settlement window, correction window, or Time-of-Time ledger reference. The recorder may capture event ordering without placing raw private data in a public ledger.

A time-asset record may include event_id, identity_anchor, terminal_reference, time_domain_reference, time_window, event_category, behavior_context, policy_version, eligibility_state, evidence_commitment, prior_state, new_state, and receipt_reference.

The time-asset record may support mint eligibility, service credit, settlement eligibility, reputation update, licensing status, audit ordering, or index update. It need not represent a currency and may instead be a technical eligibility or receipt state.

Time-domain binding supports replay prevention and duplicate detection. A terminal operation outside its validity window may be rejected or placed in re-verification. A duplicated event in the same time window may be denied, quarantined, or routed to a bounded-correction interface.

### Wallet, Banking, Payment, and Clearing Endpoint

The wallet and clearing endpoint module receives payment, settlement, service credit, transfer, or clearing requests associated with a ReadName endpoint or domain-linked terminal credential. The module verifies identity anchor, terminal authentication, behavior-time proof, policy version, access state, wallet scope, and risk state before authorizing the operation.

A payment authorization record may include payer_endpoint, payee_endpoint, amount_or_value_reference, currency_or_unit_type, behavior_time_proof, wallet_scope, clearing_endpoint, nonce, validity_window, policy_version, settlement_status, and receipt_reference.

A clearing receipt may identify the event type, endpoint reference, identity anchor, terminal reference, prior state, new state, verification result, settlement reference, evidence commitment, ledger or database reference, and signature reference. The receipt may be used by a wallet, marketplace, clearinghouse, audit service, or index engine.

The module may interoperate with conventional banks, digital wallets, distributed ledgers, internal credits, behavior-linked value units, service credits, and asset exchange platforms. The terminal infrastructure is not limited to a single currency or payment network.

### QR Replacement Payment Handshake

A payment request may be authorized using a behavior-time proof and domain-linked credential instead of, or in addition to, a static QR identifier. A merchant domain, user domain, terminal endpoint, or wallet endpoint may participate in the payment handshake.

In one embodiment, a user terminal receives a merchant domain payment request, signs an authorization payload with an authorization SDK, attaches a behavior-time proof, checks terminal lifecycle status, and submits the package to a clearing endpoint. The clearing endpoint returns a receipt and updates terminal or wallet state.

The handshake may include payer_domain, merchant_domain, payment_context, policy_version, nonce, validity_window, behavior_proof_reference, wallet_scope, settlement_reference, and receipt_status. The handshake may also include a static QR reference, but the static QR is not the controlling trust source.

This structure improves security and auditability because the payment is tied to a terminal endpoint, time window, behavior proof, policy state, and receipt. A compromised QR image alone does not authorize payment without the required terminal and behavior-time checks.

### Identity Lifecycle and Credential Revocation

An RTT endpoint, domain credential, identity anchor, terminal record, or wallet scope may have lifecycle states including initialized, pending, active, limited, suspended, revoked, expired, inherited, transferred, recovered, disputed, quarantined, or re-verification-required.

A lifecycle controller may receive lifecycle events such as initialization, verification, renewal, inheritance, transfer, suspension, revocation, recovery, dispute, expiration, and finalization. Each event may generate a receipt and may update endpoint records, access registries, wallet scopes, and synchronization state.

Revocation may occur after terminal compromise, invalid nonce use, duplicate credentials, unauthorized transfer, expired proof, failed measured boot, policy conflict, or governance decision. Revocation may be global or scoped to a specific terminal module, such as communication, wallet, marketplace, governance, or audit.

Inheritance or transfer may be implemented as a scoped lifecycle event rather than as an uncontrolled ownership assertion. A transfer may require a policy version, authorization signature, identity anchor, time window, evidence commitment, recipient endpoint, and receipt.

### Cross-Domain Synchronization Channel

A cross-domain synchronization channel synchronizes identity, credential, terminal, transaction, revocation, receipt, access, risk, and index states across domain systems. The channel may be implemented using APIs, message queues, smart-contract events, peer-to-peer messages, append-only logs, or database replication.

A synchronization packet may include source_domain, target_domain, endpoint_reference, state_type, prior_state, new_state, policy_version, time_window, evidence_commitment, signature_reference, and receipt_reference. The packet may be approved, denied, delayed, quarantined, or marked re-verification-required.

Synchronization may support domain categories such as national, industry, time, cultural, alphabetical, and numerical systems. A revocation in one domain may propagate to another domain if policy permits. A wallet settlement receipt may synchronize with a marketplace listing or audit record.

The channel may support local autonomy. A terminal or edge node may operate with cached state during offline or degraded connectivity and later synchronize with a global namespace or policy server. Conflicts may be resolved through policy, timestamp, receipt priority, or dispute handling.

### Cross-Domain Mapping Module

The cross-domain mapping module maps domain references, identity anchors, terminal identifiers, service endpoints, marketplace listings, wallet endpoints, governance endpoints, and resource references. Mapping may use semantic, temporal, behavioral, geographic, category, policy, or jurisdiction logic.

For example, a ReadName used with a health context may map to a healthcare service endpoint, whereas the same ReadName used with a wallet context may map to a payment endpoint. A governance context may map to a voting or policy endpoint. A marketplace context may map to a listing or licensing endpoint.

Mapping outputs may include endpoint_role, canonical_reference, route_context, policy_version, validity_window, access_state, revocation_state, and receipt_reference. A mapping output may be used by communication routing, navigation resolution, payment clearing, asset listing, or terminal access control.

The mapping module improves interoperability by allowing different user interfaces and platforms to resolve a common domain-linked terminal state without forcing all applications to use the same visible identifier or database.

### Terminal Access Registry

The terminal access registry controls terminal modules including identity, communication, navigation, wallet, clearing, marketplace, governance, audit, receipt retrieval, and index update modules. Each module may have an access state such as enabled, disabled, limited, suspended, revoked, pending, expired, disputed, or re-verification-required.

A terminal access record may include terminal_id, module_id, identity_anchor, access_state, policy_version, validity_window, reason_code, dependency_state, revocation_state, and receipt_reference. The record may be checked before routing, payment, navigation, or marketplace operations proceed.

The registry may enforce separation of permissions. A terminal may be authorized for communication but not for wallet settlement, authorized for marketplace listing but not for governance, or authorized for audit receipt retrieval but not for raw evidence disclosure.

Access decisions may be written back to a behavioral ledger, terminal state record, or access registry. A denied access request may reduce trust or trigger re-verification. A successful re-verification may restore an access state.

### Behavior, Biometric, and Sensor Proof Commitments

A terminal operation may be supported by a privacy-preserving proof derived from behavioral, biometric, physiological, sensor, location, device, or activity signals. Examples include liveness state, motion pattern, breathing state, heart rhythm, interaction rhythm, typing or gesture pattern, service event, or contextual activity.

Raw private data need not be stored in a public ledger. Instead, the system may store an evidence commitment, hash, proof result, credential reference, or selective disclosure record. The raw data may remain local to a terminal, encrypted storage, trusted environment, or user-controlled vault.

A behavior proof record may include proof_id, proof_type, identity_anchor, terminal_reference, time_window, signal_category, confidence_score, privacy_flag, evidence_commitment, policy_version, and receipt_reference. A verifier may check the proof record without receiving all raw sensor values.

Proof commitments may be used for communication route authorization, SIM-free terminal authentication, wallet authorization, identity lifecycle control, navigation confidence, access registry decisions, and risk isolation.

### Optional Hardware-Attested Terminal

In higher-security embodiments, an RTT terminal may include a physical unclonable function module, a trusted execution environment, a measured-boot verifier, a root-key derivation module, secure storage, a behavior proof engine, and a remote attestation interface.

A PUF module may generate an unclonable device fingerprint in response to a challenge. A key derivation function may derive a root key from the fingerprint and device-specific data. A trusted execution environment may measure firmware, operating system, and protocol code before releasing or using the root key.

A hardware attestation report may include a measurement report, terminal identifier, root-key certificate reference, nonce, validity window, policy version, and signature. A remote verifier may approve, reject, quarantine, or require re-provisioning of the terminal according to the report.

The optional hardware-attested embodiment may be used for medical terminals, banking terminals, ATM endpoints, vehicle endpoints, IoT devices, institutional terminals, or high-value asset transactions. The broader ReadName terminal infrastructure remains implementable without requiring a specific hardware root of trust.

### Event Metadata Lock and Machine-Verifiable Receipt

An event metadata lock binds event metadata to a terminal, identity anchor, time window, nonce, policy version, evidence commitment, and receipt status. The event may relate to communication, payment, navigation, identity lifecycle, terminal access, marketplace listing, licensing, transfer, audit, or index update.

A metadata lock may be implemented as a signed record, hash commitment, token metadata object, append-only ledger event, database row, certificate, or other machine-verifiable package. It may optionally be represented by an NFT or similar token, but the technical lock is not limited to NFT implementation.

A machine-verifiable receipt may include receipt_id, event_type, endpoint_reference, identity_anchor, terminal_reference, prior_state, new_state, policy_version, time_window, verification_result, evidence_commitment, signature_reference, ledger_reference, and receipt_status.

Receipts may be consumed by other modules. A communication receipt may update a relationship state. A payment receipt may update wallet settlement. A lifecycle receipt may update terminal access. A licensing receipt may update asset package status. This interoperation improves auditability and licensing detectability.

### Risk Isolation, Bounded Correction, and Finality Interfaces

A risk management component may detect abnormal routes, invalid nonces, duplicate credentials, replay attempts, expired validity windows, terminal compromise, payment conflicts, unauthorized transfers, policy conflicts, or disputed receipts. Detection may trigger isolation, quarantine, suspension, step-up verification, delayed routing, or recovery.

A bounded-correction interface may support dispute, freeze, mask, annotation, callback, clawback, rollback, reissue, invalidate, restrict, or correction states while preserving a privacy-protected audit trail. The interface may be limited by correction windows, policy versions, receipt states, and authority requirements.

A finality interface may assign states such as pending, proofed, authorized, minted, listed, licensed, transferred, cleared, indexed, final, expired, revoked, or closed. Once finality is assigned, unauthorized reopening, duplicate minting, duplicate clearing, duplicate licensing, duplicate transfer, duplicate indexing, or replay may be rejected.

The risk, correction, and finality interfaces may be implemented within the ReadName terminal infrastructure or through interoperable modules. They are useful for asset outputs, wallet settlement, governance, licensing, and audit without requiring the infrastructure to be limited to a single marketplace or clearinghouse.

### Interoperable Asset, Licensing, Marketplace, and Index Outputs

Terminal operations may output interoperable asset records including licensing packages, transfer packages, marketplace listings, audit records, asset packages, valuation metadata, and index updates. These outputs may reference terminal receipts rather than duplicating raw private evidence.

A licensing package may include license_id, resource_reference, licensor_identity_anchor, licensee_endpoint, scope, territory, duration, policy_version, payment_reference, revocation_condition, evidence_commitment, and receipt_reference. A transfer package may include transferor endpoint, transferee endpoint, asset reference, authorization proof, and finality status.

A marketplace listing may include listing_id, identity_anchor, resource_reference, trust_index, time_index, terminal_status, license_state, settlement_state, audit_state, valuation_metadata, and receipt_reference. A listing may be active, pending, suspended, disputed, licensed, transferred, cleared, or closed.

Index outputs may include trust index, time index, route index, payment eligibility index, terminal reliability index, licensing status index, audit readiness index, or asset valuation index. An index update may be generated from receipts rather than from unverified claims.

### Terminal Mesh and Governance Embodiments

In some embodiments, multiple terminals form a personal, family, community, institutional, regional, emergency, or service governance cluster. A cluster may support role delegation, permission trees, inheritance, trust-scored access rights, quorum verification, dispute resolution, offline trust vaults, and later synchronization.

A permission tree may identify parent terminal, child terminal, delegated role, scope, validity window, revocation condition, policy version, and receipt reference. A delegated role may authorize service access, wallet access, emergency access, audit access, governance participation, or marketplace operations.

An offline trust vault may cache terminal state, credential state, receipts, trust proofs, and policy data during offline operation. When connectivity returns, the vault may synchronize with one or more domain systems, resolving conflicts through policy, quorum, timestamp, or receipt priority.

Terminal mesh governance is optional and may be applied in specialized deployments. It does not replace the ReadName terminal core; instead, it extends access control, recovery, inheritance, and emergency operation for groups of terminals.

### API and Platform Integration

The infrastructure may expose application programming interfaces for ReadName initialization, endpoint lookup, SIM-free authentication, message routing, payment clearing, navigation resolution, time-asset binding, terminal access control, lifecycle update, revocation, receipt retrieval, risk isolation, index update, marketplace listing, licensing, transfer, and audit verification.

An API request may include operation_type, identity_anchor, terminal_reference, domain_reference, context_field, time_window, nonce, policy_version, proof_reference, requested_module, and payload_reference. An API response may include status, endpoint_reference, receipt_reference, reason_code, lifecycle_state, access_state, settlement_state, and index_update_reference.

External platforms may include web applications, wallet systems, marketplace systems, exchanges, clearing services, identity services, healthcare platforms, education credential systems, IoT management systems, and governance dashboards. Each platform may consume receipts without receiving raw private evidence.

API integration supports adoption because a platform can use its own user interface while relying on the ReadName terminal infrastructure for endpoint resolution, terminal authentication, wallet settlement, access control, and audit-ready receipts.

### Representative Data Structures

The following representative data structures illustrate machine-readable records. Fields are non-limiting and may be implemented as JSON, XML, database rows, ledger events, protocol buffers, certificates, signed endpoint records, or other structured formats.

An RTT endpoint record may include rtt_id, ReadName, domain_reference, identity_anchor, terminal_reference, communication_endpoint, wallet_endpoint, clearing_endpoint, access_registry_reference, policy_version, lifecycle_state, validity_window, revocation_state, evidence_commitment, receipt_reference.

A communication route package may include sender_endpoint, recipient_endpoint, behavioral_context, relationship_context, routing_field, verification_field, nonce, validity_window, payload_reference, privacy_flag, policy_version, route_status, receipt_reference.

A SIM-free authentication record may include terminal_id, domain_reference, public_key_reference, time_signature, behavior_proof_reference, session_state, nonce, validity_window, policy_version, revocation_state, optional_attestation_reference, receipt_reference.

A payment authorization record may include payer_endpoint, payee_endpoint, payment_context, wallet_scope, currency_or_unit_type, amount_or_value_reference, behavior_time_proof, clearing_endpoint, nonce, validity_window, policy_version, settlement_status, receipt_reference.

A lifecycle record may include lifecycle_event_id, endpoint_reference, prior_state, new_state, reason_code, authority_reference, policy_version, time_window, evidence_commitment, signature_reference, receipt_reference.

A risk isolation record may include risk_event_id, affected_endpoint, risk_type, detection_source, prior_state, isolation_state, recovery_condition, policy_version, time_window, reason_code, receipt_reference.

An interoperable asset output record may include asset_output_id, resource_reference, endpoint_reference, identity_anchor, license_state, transfer_state, marketplace_state, audit_state, valuation_metadata, policy_version, finality_state, receipt_reference.

### Representative Operating Sequences

In a ReadName generation sequence, a user or terminal submits identity, system, demand, time-window, and nonce inputs. The DGE generates a candidate endpoint, checks collisions, binds an identity anchor, creates an endpoint record, assigns lifecycle status, and generates a receipt.

In a switchless communication sequence, a sender terminal submits a message package referencing a recipient domain endpoint. The communication module validates behavioral context, terminal authentication, nonce, validity window, lifecycle state, and access status. The module routes, denies, quarantines, or requests re-verification and then generates a receipt.

In a SIM-free authentication sequence, a terminal presents a domain keypair signature, time signature, behavior proof, terminal identifier, nonce, and validity window. The verifier checks lifecycle state and policy version and returns an approved, rejected, quarantined, or re-verification-required status.

In a QR replacement payment sequence, a merchant domain generates a payment request. The user terminal signs a payment authorization using an authorization SDK, attaches behavior-time proof, and submits the package to a clearing endpoint. The clearing endpoint validates the package and returns a settlement receipt.

In a GPS-free navigation sequence, a terminal submits an intent signal. The route resolver evaluates behavior density, time continuity, interaction diversity, route confidence, domain context, and access state. It returns a route or endpoint result and a receipt.

In a lifecycle revocation sequence, a risk engine detects invalid nonce reuse, duplicate credential use, terminal compromise, or payment conflict. The lifecycle controller changes the endpoint state to limited, suspended, revoked, quarantined, or re-verification-required and synchronizes the state across domain systems.

In an optional hardware-attestation sequence, a PUF module produces a fingerprint, a TEE measures boot state, a root key is derived or released, and a remote attestation report is generated. The terminal credential is approved or denied according to the report.

In an asset output sequence, a terminal event receipt is referenced by a licensing package, transfer package, marketplace listing, audit record, or valuation index. The output record uses the receipt as proof of terminal, identity, policy, and time state.

### Technical Advantages

The disclosed infrastructure reduces dependence on telephone numbers, SIM credentials, and switch codes as controlling endpoints by using domain-resolved terminal records with identity anchors, behavior-time proof, terminal state, policy version, nonce, validity window, and receipt status.

The infrastructure improves cross-namespace interoperability by allowing domain-linked references to resolve into communication, wallet, clearing, access, marketplace, governance, and audit endpoints while preserving separate scopes and lifecycle states.

The infrastructure provides concrete data structures and state machines. Endpoint records, authentication records, payment records, lifecycle records, risk records, metadata locks, receipts, and index outputs provide implementation detail and allow audit, testing, and licensing detection.

The infrastructure improves privacy by storing evidence commitments, proof results, hashes, or references instead of raw private biometric, behavioral, wallet, or sensor data when possible. Raw data may remain local or encrypted while the receipt provides verification state.

The infrastructure supports bounded correction and finality. This reduces duplicate minting, duplicate clearing, duplicate licensing, duplicate transfer, replay, and unauthorized reopening while preserving an auditable state trail.

The infrastructure supports asset-package and licensing outputs without collapsing the terminal invention into a single marketplace or registry. Receipts can be consumed by different systems for due diligence, audit, valuation, marketplace listing, settlement, or governance.

The infrastructure can be implemented in ordinary software deployments and can also be strengthened through optional hardware-attested terminal embodiments. This flexibility supports web, mobile, IoT, healthcare, banking, vehicle, institutional, and edge deployments.

### Industrial Applicability

The disclosed infrastructure may be used in communication platforms, identity platforms, mobile terminals, web terminals, digital wallets, banking systems, clearing systems, healthcare systems, IoT networks, vehicle networks, education credentialing, marketplaces, exchanges, governance dashboards, asset registries, licensing platforms, and audit services.

In a communication deployment, the system allows a domain-linked terminal reference to route communications without relying on a phone number or SIM credential as the controlling endpoint. In a wallet deployment, the same or related terminal reference may authorize payment and generate settlement receipts.

In a healthcare or safety deployment, optional hardware attestation and privacy-preserving proof commitments may support higher trust without exposing raw medical or biometric data. In an asset deployment, terminal receipts may support licensing, transfer, audit, and valuation outputs.

The same technical architecture can therefore serve as an interoperable terminal layer across identity, communication, wallet, routing, lifecycle, receipt, and asset-output systems.

### Canonical Request Envelope and Field Normalization

The infrastructure may employ a canonical request envelope for every terminal operation. The envelope may include an operation type, endpoint reference, identity anchor, terminal reference, domain reference, requested module, context field, time-window field, nonce, policy version, evidence commitment, signature reference, and requested output. The fields may be ordered, serialized, hashed, or signed before verification so that different servers, edge nodes, wallets, or terminals evaluate the same operation consistently.

Canonicalization may include converting visible ReadName strings to canonical endpoint identifiers, normalizing time windows, rejecting ambiguous encodings, removing unused transport headers, and binding the request to a policy version. A canonical request may be represented as JSON, XML, CBOR, protocol buffers, a signed certificate, a ledger event, or a database record. The selected representation does not alter the technical function of binding the fields into a verifiable request.

The canonical request envelope may reduce replay and substitution risk. For example, a communication request intended for a recipient domain endpoint cannot be reused as a payment request because the operation type, requested module, policy version, and wallet scope would not match. A route request cannot be reused after expiration because the validity window and nonce would fail verification.

The response to a canonical request may use a corresponding canonical response envelope. The response may include status, reason code, prior state, new state, endpoint reference, proof result, access result, route result, payment result, index update reference, synchronization state, and receipt reference. This response becomes a machine-verifiable artifact that later modules can consume without reprocessing raw evidence.

The request envelope therefore provides an implementation path for the endpoint record architecture. It allows a developer to implement the claimed terminal infrastructure as a set of interoperable API calls while preserving the same identity, terminal, behavior-time, policy, lifecycle, and receipt relationships described for the ReadName Token Terminal.

### Dynamic Domain Generation and Collision Handling Details

A Dynamic Domain Generation Engine may derive a candidate ReadName terminal endpoint by combining identity reference, system reference, demand or context type, time-window value, nonce or random seed, policy version, and domain category into an input vector. The input vector may be processed by a hash, keyed hash, deterministic function, allocation rule, registry lookup, or policy-controlled mapping function.

The generation process may output a candidate endpoint, canonical endpoint identifier, display ReadName, policy version, collision status, lifecycle state, and receipt reference. The candidate endpoint may be rejected if it conflicts with an active, reserved, suspended, revoked, inherited, transferred, expired, quarantined, or disputed endpoint record. The engine may then request a new nonce, change a time window, alter a category field, or place the candidate into dispute.

Collision handling may be performed before a terminal credential is issued. A collision response may include accepted, rejected, pending, alternate-generated, reserved, disputed, or governance-review-required. Each collision response may be recorded with evidence commitment and generation receipt so that later ownership, inheritance, transfer, or recovery operations can be audited.

In some embodiments, a generated endpoint may be stable for a user, institution, device, or resource. In other embodiments, a generated endpoint may be session-scoped, time-scoped, context-scoped, merchant-scoped, service-scoped, or emergency-scoped. A stable endpoint and a session endpoint may share an identity anchor while maintaining different lifecycle, privacy, and receipt states.

By defining the generation inputs, collision state, lifecycle state, and receipt output, the DGE operates as a technical allocation module rather than a mere naming preference. The generated ReadName terminal endpoint becomes a stateful terminal object that can be authenticated, routed, settled, revoked, synchronized, and audited.

### Endpoint Record Versioning and Privacy-Preserving References

An endpoint record may be versioned when any material field changes. A material change may include a change in identity anchor, terminal reference, communication endpoint, wallet scope, clearing endpoint, access registry reference, lifecycle state, policy version, revocation state, or receipt reference. A version identifier can prevent old records from being used as current authorization state.

Versioning may be implemented through prior record hash, current record hash, sequence number, ledger index, database revision, signed update packet, or append-only event. A record update may not overwrite the prior record. Instead, the prior state and new state may both be referenced in a receipt so that an auditor can determine when and why the endpoint changed.

Privacy-preserving references may be used for sensitive fields. For example, a biometric signal, behavior signal, wallet secret, private message payload, or medical indicator may be represented by a hash, commitment, encrypted pointer, selective-disclosure credential, or local verification flag. Shared records may contain proof results rather than raw private evidence.

The endpoint record may maintain scope separation. A communication endpoint may be visible to a communication module without revealing wallet balance. A wallet endpoint may verify settlement eligibility without revealing message payload. A governance endpoint may determine voting or access status without receiving raw biometric data. The access registry controls these scopes.

Record versioning and privacy-preserving references allow the system to be deployed in regulated environments. An institution can verify receipt status, lifecycle status, and policy version while the user or terminal retains local control of private evidence. This creates an auditable terminal architecture without requiring universal disclosure of raw identity or behavior data.

### Behavior-Time Proof Metric Implementations

A behavior-time proof may be implemented from signals already associated with a terminal event, including a time-window field, behavior category, interaction record, route context, liveness signal, terminal state, and evidence commitment. The proof may be a binary verification result, a confidence value, a signed credential, a hash commitment, a zero-knowledge proof, or a selective-disclosure credential.

Behavior density may be represented by a count, weighted count, or normalized count of verified behavior events in a policy-defined time window. The events may include communication attempts, payment authorizations, service interactions, sensor confirmations, terminal unlocks, or route confirmations. The system may compare the value to a policy threshold or use it as one factor in route confidence.

Time continuity may be represented by the existence or ratio of sequential valid time-window proofs for a terminal or endpoint. Breaks in time continuity may result from expired validity windows, repeated nonce values, missing receipts, policy conflicts, device compromise, or lifecycle suspension. A time continuity value may therefore support replay detection and credential recovery decisions.

Interaction diversity may be represented by a count or distribution of different counterparties, service categories, domain categories, terminal modules, or interaction classes during a policy window. Low interaction diversity may be normal for a specialized terminal, while an unexpected change may trigger re-verification. A policy can interpret diversity according to terminal class.

Route confidence may be derived from behavior density, time continuity, interaction diversity, relationship state, terminal reliability, risk state, and access state. A route confidence output may be routed, denied, delayed, quarantined, alternate-route-selected, or re-verification-required. These values are non-limiting implementation examples of the behavior-time fields described for routing, payment, and access control.

### Switchless Communication as a Single-Function Deployment

Although the infrastructure supports identity, communication, wallet, clearing, access, and asset outputs, a deployment may begin as a communication-only deployment. In such a deployment, the ReadName terminal endpoint record may include an identity anchor, terminal reference, communication endpoint, policy version, lifecycle state, and route receipt reference, while wallet and marketplace fields remain inactive or unassigned.

A communication-only deployment may route text, voice, video, service signals, credential signals, emergency notices, or terminal-access messages. The controlling endpoint is the domain-linked terminal reference, not a phone number, SIM credential, switch code, or platform username. Conventional networks may carry packets, but they are not the controlling identity or route authority.

A sender terminal may sign a message package using a domain keypair or authorization SDK. The package may include sender endpoint, recipient endpoint, behavior context, verification field, nonce, validity window, policy version, and payload reference. The route verifier may check endpoint lifecycle, sender authority, recipient status, risk state, and route confidence.

If verification succeeds, the route may be delivered or queued. If verification fails, the route may be denied, delayed, quarantined, redirected, or marked re-verification-required. The result is captured in a route receipt. The receipt can later update relationship state, trust index, access state, or cross-domain synchronization state.

This deployment illustrates that the terminal infrastructure can provide direct technical utility even before wallet settlement or asset-output functions are activated. It also provides a narrow implementation path for switchless communication using the same endpoint record fabric.

### Domain-Anchored Payment and QR-Replacement Deployment

A payment deployment may activate wallet, payment, clearing, and receipt fields of the endpoint record. A payer ReadName terminal may sign a payment authorization that references a payee or merchant domain endpoint, behavior-time proof, nonce, time window, wallet scope, clearing endpoint, and policy version.

A merchant may present a merchant domain reference, payment link, QR display, near-field signal, or API request. A QR display may transport a request, but the controlling trust source is the domain-linked credential and terminal state rather than the static code image. A copied image does not authorize payment without a valid terminal proof and receipt workflow.

The clearing endpoint may verify payer endpoint, payee endpoint, wallet scope, nonce, validity window, behavior-time proof, lifecycle status, risk status, and policy version. If verification succeeds, a payment authorization record and settlement receipt are generated. If verification fails, a denial, hold, quarantine, or re-verification receipt may be produced.

A settlement receipt may include payer endpoint, payee endpoint, amount or value reference, asset type, clearing status, prior state, new state, evidence commitment, policy version, and signature reference. The receipt can be used by a wallet, merchant system, clearinghouse, audit service, index engine, or marketplace.

The payment deployment shows how the same ReadName terminal endpoint can support a safer dynamic payment handshake while preserving compatibility with existing payment rails. Static QR, wallet addresses, and bank references can remain optional supporting references rather than controlling credentials.

### API and SDK Traceability for Implementation and Audit

An authorization SDK may expose functions for creating, signing, verifying, submitting, and retrieving terminal operation packages. Example functions may include initializeReadName, resolveEndpoint, signCommunication, signPayment, verifyBehaviorTimeProof, updateLifecycle, submitReceipt, synchronizeState, retrieveIndex, and revokeCredential.

Each SDK function may operate on structured fields including rtt_id, domain_reference, identity_anchor, terminal_reference, operation_type, behavior_time_proof_reference, nonce, validity_window, policy_version, access_state, lifecycle_state, evidence_commitment, signature_reference, and receipt_reference. These field names are non-limiting examples of the technical data relationships described herein.

A server API may expose endpoint lookup, SIM-free authentication, switchless routing, payment clearing, time-asset binding, terminal access control, lifecycle update, risk isolation, receipt retrieval, marketplace listing, licensing, transfer, audit verification, and index update. A client may call a subset of APIs according to its permission scope.

API traceability can support audit and troubleshooting. For example, a failed payment can be traced from payment authorization record to terminal authentication record to behavior-time proof to lifecycle state to risk isolation receipt. A communication denial can be traced from route request to recipient endpoint state to policy version to route receipt.

By defining externally consumable data structures and responses, the infrastructure can be integrated into wallets, browser applications, mobile applications, enterprise applications, IoT gateways, medical terminals, and marketplace systems. The same fields also provide objective machine artifacts for compliance review and technical due diligence.

### Minimal Reference Implementation

A minimal reference implementation may include a ReadName registry service, endpoint resolver, key-management component, SIM-free authentication verifier, message routing service, wallet or settlement test module, receipt store, and lifecycle controller. The components may be implemented as a web service and database before being distributed across ledger or peer nodes.

In the minimal implementation, a user registers a ReadName endpoint. The DGE receives identity reference, system reference, demand or context type, time-window field, and nonce. The endpoint record is created with identity anchor, communication endpoint, wallet endpoint, lifecycle state, policy version, and receipt reference.

The user terminal generates or receives a domain keypair. A terminal operation is signed with the domain keypair and includes a time signature, nonce, validity window, and behavior-time proof or proof reference. The resolver verifies the endpoint record and lifecycle state before allowing message routing or payment authorization.

A first demonstration operation may be a switchless message from one ReadName endpoint to another. A second demonstration operation may be a payment authorization from a user endpoint to a merchant endpoint. Both operations produce machine-verifiable receipts and update terminal state or index state.

The minimal implementation can run over ordinary Internet connectivity. It does not require replacing carrier networks, DNS, wallet systems, or payment rails in the first deployment. It demonstrates the key technical shift: the ReadName terminal endpoint is the controlling identity, routing, and receipt object.

### Prior-Record and State Integrity

For state integrity, a terminal operation may reference a prior receipt, prior endpoint record, prior lifecycle state, or prior index state. A verifier may reject an operation if the referenced prior state does not match the current system state or if the operation attempts to skip a required lifecycle transition.

Prior-state references can prevent unauthorized reopening. For example, a terminal previously marked revoked cannot be restored to active without a recovery operation. A payment already settled cannot be submitted again as a new settlement without a new authorization or correction record. A route denied for expired validity cannot be reused after expiration.

The infrastructure may maintain state integrity through hashes, sequence numbers, ledger references, signed database revisions, append-only logs, or receipt chains. Different deployments may use different storage technologies, but each maintains the relationship among prior state, new state, policy version, and receipt reference.

A state transition may be local to a module or global across the terminal record. A communication module may be suspended while wallet access remains enabled. A wallet module may be frozen while communication remains available. A governance module may require re-verification while receipt retrieval remains enabled.

This state separation supports practical deployment. A user or institution does not lose all terminal functions because one module is disputed. Risk can be isolated to the affected operation while the rest of the terminal remains usable under policy.

### Failure Modes and Recovery Workflows

The system may define failure modes for invalid nonce, expired validity window, conflicting policy version, duplicate credential, mismatched endpoint record, unauthorized lifecycle transition, compromised terminal state, inconsistent receipt, and failed proof verification. Each failure mode may produce a structured receipt or status code.

A recovery workflow may require re-verification of identity anchor, re-signing by an authorization SDK, key rotation, domain-control confirmation, hardware attestation, receipt reconciliation, or governance approval. The workflow may restore access to one module without restoring all modules at once.

For example, if a communication key is compromised, the communication module may be suspended while wallet settlement remains limited or disabled until separate verification is completed. If a wallet operation appears duplicated, the payment module may enter hold or quarantine while a communication module remains active.

When recovery succeeds, the lifecycle controller may issue a recovery receipt that references the risk event, recovery evidence, prior state, new state, and policy version. When recovery fails, the system may maintain suspension or revocation and synchronize that state across domain systems.

Failure and recovery workflows are technical mechanisms because they define how computer systems handle invalid inputs, conflicting states, and security failures. They also provide audit-ready artifacts for compliance, licensing, and dispute resolution.

### Interoperability with Existing Networks and Platforms

The terminal infrastructure may interoperate with existing telephone networks, cellular data networks, Wi-Fi networks, satellite links, DNS systems, wallet systems, payment gateways, identity providers, and marketplaces. Such systems may act as transport or supporting references without becoming the controlling identity or route source.

For example, a cellular network may provide data transport to a mobile device, but the SIM credential is not the controlling terminal credential for a ReadName operation. A QR code may transport a merchant request, but the QR code is not the controlling payment credential. A GPS coordinate may support route context, but GPS is not the sole controlling route source.

A wallet address may receive funds while the ReadName endpoint record controls payment authorization and settlement receipt. A domain registrar may provide a public namespace while the endpoint resolver controls terminal state, lifecycle, and receipt mapping. A marketplace may show listings while asset-output records link the listing to terminal receipts.

This interoperability allows incremental adoption. A platform can integrate one module, such as endpoint lookup or SIM-free authentication, before integrating wallet clearing or asset outputs. The architecture remains consistent because all modules reference the endpoint record and receipt fabric.

The ability to use legacy transport while replacing controlling identity and route credentials is a key technical advantage. It avoids requiring immediate replacement of global networks while creating a new terminal control layer above them.

### Security Considerations for Key and Nonce Management

Domain keys may be separated by scope, including communication, payment, lifecycle, recovery, governance, and receipt retrieval keys. Scope separation reduces risk because a key authorized for message routing cannot automatically authorize wallet settlement or domain transfer unless policy permits.

Nonce management may be performed by a terminal, server, ledger, wallet module, or verifier. A nonce may be single-use, time-window-scoped, operation-scoped, endpoint-scoped, or key-scoped. A verifier may reject reused nonce values or nonce values outside a validity window.

Key rotation may occur after policy expiration, compromise indication, lifecycle transition, device replacement, inheritance, transfer, recovery, or governance event. A key rotation receipt may link prior key reference, new key reference, authority reference, time window, policy version, and reason code.

A secure session reference may bind a temporary communication or payment session to an endpoint record and validity window. The secure session may expire automatically after completion, time-out, route denial, payment denial, or risk isolation.

These key and nonce controls strengthen the technical implementation of SIM-free authentication. They define how the system prevents replay, cross-module misuse, and unauthorized terminal operations without relying on a SIM credential as the controlling identity source.

### Asset Output and Licensing Detectability

Asset outputs may use machine-verifiable receipts as evidence of terminal state, identity anchor, policy version, time window, and operation status. A licensing package, transfer package, marketplace listing, audit record, or valuation metadata record may therefore reference a terminal receipt rather than relying on a manual assertion.

A licensing package may identify licensor endpoint, licensee endpoint, resource reference, scope, territory, duration, payment reference, revocation condition, evidence commitment, and receipt reference. A transfer package may identify transferor endpoint, transferee endpoint, asset reference, authority proof, finality state, and receipt reference.

A marketplace listing may derive trust index, time index, terminal reliability, license state, settlement state, audit readiness, and valuation metadata from endpoint records and receipts. The listing does not need raw private evidence if the receipt provides sufficient verification status and evidence commitment.

These outputs are interoperable. A licensing platform, payment system, exchange, marketplace, audit service, or internal asset registry may consume the same receipt reference. Different platforms can therefore verify terminal operations using shared machine-readable artifacts while maintaining separate business interfaces.

Licensing detectability is enhanced because a deployed system that uses ReadName endpoint records, SIM-free authentication, wallet-clearing receipts, access registries, and asset-output records exposes technical artifacts that can be compared to the claimed record relationships and API fields.

### Representative Platform Configurations

A web configuration may implement endpoint resolution through a browser application and server API. The browser holds a domain key or delegates signing to a wallet or secure module. The server resolves endpoint records, verifies nonce and validity window, routes messages, authorizes payments, and returns receipts.

A mobile configuration may implement the ReadName terminal as a mobile application. The application may store domain keys in secure storage, obtain sensor or liveness proofs locally, sign operations through an authorization SDK, and synchronize receipts with a server or ledger. The mobile device may use cellular data while avoiding SIM as the controlling terminal credential.

An IoT configuration may assign endpoint records to sensors, meters, vehicles, medical devices, home devices, or industrial controllers. The device may submit time-windowed messages, status proofs, or payment-like service credits. The endpoint record allows remote systems to authenticate the device without relying on a telephone number.

An enterprise configuration may integrate the terminal access registry with employee credentials, departmental domains, service endpoints, wallet-like internal budgets, and audit systems. Access states can be limited, suspended, or revoked by module rather than by deleting all accounts.

A public service configuration may use domain-linked terminals for healthcare, education, emergency response, permits, benefits, identity recovery, or institutional communication. Privacy-preserving proof commitments allow service eligibility to be verified without unnecessary disclosure of raw sensitive evidence.

### Representative Status Codes and Receipts

An operation status may include approved, denied, delayed, pending, expired, quarantined, disputed, suspended, revoked, redirected, settled, cleared, listed, licensed, transferred, recovered, final, or re-verification-required. Each status may be represented in a machine-verifiable receipt.

A denial receipt may include reason code, invalid field, policy version, time field, endpoint reference, evidence commitment, and recovery option. A denial receipt is useful because it allows clients to distinguish between invalid nonce, expired time window, revoked endpoint, insufficient access state, payment hold, and route denial.

A quarantine receipt may include quarantine scope, affected module, recovery condition, time window, risk reference, and synchronization requirement. The quarantine may affect only communication, wallet, marketplace, governance, or terminal access modules according to policy.

A finality receipt may include finality type, protected operation, prior state, final state, duplicate-prevention reference, unauthorized-reopening-prevention state, and audit reference. Finality may apply to settlement, licensing, transfer, indexing, or lifecycle operations.

The use of structured status codes and receipts helps developers implement reliable clients. It also assists audits because each system response is mapped to an explicit state transition rather than an ambiguous human-readable message alone.

### End-to-End Terminal Lifecycle Implementation

An end-to-end lifecycle may begin with ReadName generation and endpoint record creation. The terminal record is initialized with identity anchor, terminal reference, communication endpoint, wallet endpoint, access registry reference, policy version, lifecycle state, and receipt reference.

After initialization, the terminal may enter active state following identity-anchor verification and SIM-free terminal authentication. The active terminal can submit communication requests, payment requests, navigation intents, terminal access requests, receipt retrieval requests, or marketplace actions according to access state.

During operation, every material request may generate or update a receipt. Receipts may update trust, time, route, payment eligibility, terminal reliability, risk, access, and asset index states. Receipts may also trigger synchronization to other domain systems.

If risk is detected, the terminal or module may enter limited, suspended, quarantined, disputed, or re-verification-required state. Recovery may require proof renewal, key rotation, behavior-time proof, receipt reconciliation, domain-control verification, or governance approval. Successful recovery returns the module to an approved state.

When a terminal is transferred, inherited, revoked, or expired, the lifecycle controller issues an appropriate receipt and synchronizes that state. This lifecycle management converts a domain-linked reference into an auditable terminal object rather than a static name or account.

### Technical Distinctions and Implementation Boundaries

The infrastructure differs from a domain name service because the endpoint record stores terminal, communication, wallet, clearing, access, lifecycle, receipt, and index states rather than merely resolving a name to a network address. A domain name may be an input, but it is not the complete terminal fabric.

The infrastructure differs from a wallet address because wallet settlement is only one role of the endpoint. The same endpoint fabric also handles switchless communication, SIM-free authentication, behavior-time routing, access control, lifecycle transitions, risk isolation, and receipts.

The infrastructure differs from a decentralized identity credential because the identity anchor is bound to a stateful terminal record with communication, wallet, clearing, access, and receipt fields. Identity verification is integrated with route and settlement decisions rather than being a standalone credential presentation.

The infrastructure differs from a static QR payment system because the payment request is controlled by domain-linked credential, behavior-time proof, nonce, validity window, terminal lifecycle, and settlement receipt. A static code may transport data but does not control trust by itself.

These distinctions identify the technical center of the invention. The invention is not a label, business rule, or generic computerization of identity. It is an endpoint record fabric that coordinates several technical modules through structured fields, state transitions, and machine-verifiable receipts.

### Additional Industrial Examples

In an emergency communication example, a public agency may issue ReadName endpoints to responders, hospitals, vehicles, and field terminals. Route requests may be authenticated without relying on telephone numbers, and access states may change during emergency windows. Receipts support after-action audit.

In a medical terminal example, a patient device or clinic terminal may authenticate with SIM-free terminal authentication and optional hardware attestation. Privacy-preserving proof commitments may verify liveness or presence without exposing raw medical data to every service provider.

In a merchant payment example, a merchant domain endpoint can replace or supplement static payment codes. A customer terminal signs a domain-linked payment authorization, the clearing endpoint verifies behavior-time proof and lifecycle state, and the merchant receives a settlement receipt.

In an education credential example, a student ReadName endpoint may receive credentials, authorize communications, access services, and generate receipts for attendance or certification events. Cross-domain synchronization can propagate revoked or updated credential state to institutions.

In an asset licensing example, a patent or digital resource may be associated with a resource reference and licensing package. The terminal receipt provides evidence of licensor identity, licensee endpoint, time window, policy version, and settlement or transfer state.

### Non-Limiting Technology Choices

The system may be implemented with public DNS, private namespaces, domain registries, URI schemes, distributed identifiers, ledger names, hash identifiers, database identifiers, or combinations thereof. The ReadName terminal concept does not require a single public domain registry.

The system may use public-key cryptography, symmetric session keys, hardware-backed keys, passwordless credentials, secure enclave keys, wallet keys, institutional certificates, or domain-scoped keys. The security model is defined by the endpoint record, proof, nonce, validity window, lifecycle, and receipt fields rather than a single algorithm.

The system may store receipts in relational databases, key-value stores, append-only logs, permissioned ledgers, public ledgers, file systems, or audit services. A receipt is machine-verifiable if its fields and integrity references can be checked by an authorized verifier.

The system may be centralized, federated, distributed, peer-to-peer, edge-based, or hybrid. A centralized early deployment can implement the same terminal record fabric, while a later deployment may distribute resolver, receipt, and synchronization functions.

The drawings and examples show representative modules. Functions may be combined or separated in different implementations. For example, the endpoint resolver and access registry may run in the same service, or the wallet clearing endpoint may be operated by a separate financial-domain service.

### Conclusion

The described ReadName Token Terminal infrastructure provides a technical layer in which a domain-resolved terminal endpoint controls identity, communication, authentication, behavior-time routing, wallet settlement, access control, lifecycle state, risk isolation, receipts, synchronization, and interoperable asset outputs.

The system reduces reliance on telephone numbers, SIM credentials, switch codes, static QR identifiers, GPS coordinates, platform usernames, and single-purpose wallet addresses as controlling endpoints. Those legacy identifiers may still be used as transport or supporting references, but they do not define the controlling terminal state.

The endpoint record, authentication record, payment authorization record, lifecycle record, risk record, metadata lock, receipt, and asset output record provide concrete implementation artifacts. These artifacts support machine verification, audit, interoperability, and technical enforcement of policy.

The invention may be implemented incrementally. A deployment can begin with ReadName generation and switchless communication, add SIM-free authentication, add wallet settlement, add lifecycle and risk controls, add asset outputs, and optionally add hardware-attested terminal proof.

The foregoing description is illustrative and not limiting. The scope of protection is defined by the claims, and equivalent implementations that preserve the described relationships among domain-resolved endpoint records, terminal authentication, routing, clearing, lifecycle, receipt, and output states may be used.

### Endpoint Resolver Decision Tables

The endpoint resolver may maintain decision tables for operation type, endpoint role, access state, lifecycle state, risk state, and requested output. A communication request may be evaluated against communication-specific rules, while a payment request may be evaluated against wallet, clearing, and settlement rules. The same endpoint reference can therefore produce different decisions for different operation classes.

A decision table may include columns for input status, required proof, permitted modules, denied modules, recovery workflow, synchronization requirement, and receipt type. For example, an active terminal with valid nonce and valid behavior-time proof may route a message, while the same terminal may be blocked from wallet settlement if its wallet scope is limited.

Decision tables may be versioned by policy version. A policy update may change route eligibility, payment limits, proof requirements, or lifecycle transitions. Each decision can reference the policy version that was active when the request was evaluated, thereby avoiding ambiguity during audit or dispute resolution.

The endpoint resolver may produce explicit reason codes rather than only approve or deny. Reason codes may include invalid nonce, expired time window, inactive endpoint, revoked credential, unavailable module, wallet hold, risk isolation, missing behavior proof, insufficient access state, or synchronization conflict.

Using decision tables makes the resolver implementable and testable. A test harness can submit requests across lifecycle states and verify that the returned status, reason code, and receipt match the expected policy. This transforms the resolver from a conceptual routing function into a deterministic computer-network module.

### Communication Route Package Verification

A communication route package may be verified in multiple stages. A first stage verifies that the sender endpoint exists and has an active or permitted communication state. A second stage verifies that the recipient endpoint exists, is not revoked for the requested communication scope, and accepts the operation class. A third stage verifies nonce, validity window, policy version, and route context.

The package may include payload reference rather than raw payload. The payload reference may identify encrypted content stored locally, in a message store, in a peer channel, or in a content-addressed store. The route verifier may route the reference and receipt without reading the private payload.

The system may support synchronous and asynchronous communication. In a synchronous session, a route receipt may initiate a session key exchange. In an asynchronous session, the route receipt may authorize message storage and later retrieval. In both cases, the controlling endpoint is the domain-linked terminal reference and not a phone number.

A route package may include optional carrier, device, or platform identifiers as transport hints. Such identifiers can assist delivery but do not control identity or route authority. If the phone number or platform account changes, the ReadName endpoint may remain active and route to a new transport destination after synchronization.

The verification structure gives the switchless communication module measurable technical behavior. It defines packet fields, proof checks, failure states, receipt output, and privacy boundaries for communication operations.

### Payment Clearing Verification Details

A payment clearing request may be processed by validating a payer endpoint, payee endpoint, wallet scope, amount or value reference, unit type, behavior-time proof, nonce, validity window, access state, lifecycle state, risk state, and clearing policy. Each validation result may be recorded before settlement.

If a payment request is approved, the clearing endpoint may generate an authorization receipt and then a settlement receipt. The authorization receipt may indicate that the payer endpoint was permitted to initiate the transaction. The settlement receipt may indicate that the value operation has been cleared, settled, held, reversed, or disputed.

If a payment request is denied, the denial receipt may identify whether denial resulted from invalid endpoint, invalid proof, insufficient access state, expired time window, duplicate request, wallet hold, risk quarantine, or policy conflict. The denial receipt may include a recovery path such as re-verification or key rotation.

The clearing endpoint may interoperate with legacy bank rails, wallet ledgers, internal service credits, token systems, or institutional accounting systems. The terminal infrastructure supplies authorization and receipt logic, while the value rail may be selected by deployment policy.

This arrangement lets the same terminal endpoint serve as a communication address and payment authorization address. The architecture therefore supports payment from within a trusted communication context without making the message platform itself the sole payment authority.

### Behavior-Time Proof Data Processing Pipeline

A behavior-time proof pipeline may begin with event collection at a terminal. The terminal may collect local signals such as user action category, device state, liveness state, time-window state, route context, interaction counter, and service context. The terminal may convert these inputs to a proof reference or evidence commitment.

An alignment component may align events to policy windows. An event occurring within a valid time window may be eligible for proof generation. An event outside the window may be rejected or tagged as expired. This windowing supports replay prevention and time-based ordering without exposing continuous behavioral surveillance.

A filtering component may remove or reduce raw private values before transmission. For example, a proof result can indicate that liveness was verified without transmitting a raw biometric waveform. A route confidence value can be transmitted without exposing every prior interaction.

A proof output may be signed by the terminal, authorization SDK, secure module, or server verifier. The output may reference the endpoint record and policy version. A later wallet or communication module may use the proof output as a verification input without re-running the entire proof pipeline.

The proof pipeline supports multiple implementation strengths. A low-risk message may require a lightweight time and nonce proof. A high-value payment may require liveness proof, behavior-time continuity, hardware attestation, and risk-state verification. This supports adaptive security without changing the endpoint record architecture.

### Concrete Behavior Metric Examples

In a non-limiting implementation, behavior density may be measured as a number of verified events associated with a terminal during a policy window divided by an expected event capacity for the terminal class. A high-density value may be normal for an enterprise gateway but suspicious for a personal medical terminal depending on policy.

In a non-limiting implementation, time continuity may be measured as a sequence of consecutive valid windows in which the terminal produced receipts without invalid nonce reuse, lifecycle interruption, or risk quarantine. A discontinuity may trigger re-verification before payment or high-trust routing.

In a non-limiting implementation, interaction diversity may be measured from the number or entropy of counterparties, domain categories, service classes, or module classes contacted during a window. A sudden shift from medical endpoints to payment endpoints may require stronger proof according to policy.

In a non-limiting implementation, route confidence may combine endpoint status, lifecycle state, terminal reliability, relationship state, behavior density, time continuity, interaction diversity, risk state, and policy state. The combination may be weighted, rule-based, threshold-based, or learned under a policy-approved model.

These examples do not limit the claims to a single formula. They show that behavior-time fields can be implemented with measurable inputs derived from verified terminal events, time windows, receipts, and risk states already described in the infrastructure.

### Zero-Knowledge and Selective-Disclosure Embodiments

In some embodiments, a behavior-time proof may be implemented by a zero-knowledge proof that proves possession of a valid credential, time-window membership, liveness status, or behavior threshold without disclosing raw evidence. A verifier may check the proof result and policy version while receiving only an evidence commitment.

In other embodiments, selective disclosure credentials may reveal limited fields. For example, a merchant may receive proof that a payer endpoint is authorized and active without receiving the payer biometric signal or full identity profile. A communication recipient may receive a route authorization without receiving wallet details.

A proof may be generated locally by a terminal, within a secure module, by a wallet, by an authorization SDK, or by a server acting under user or institutional policy. The system may store the proof reference and receipt in a manner that allows later audit without exposing private raw inputs.

Zero-knowledge or selective-disclosure embodiments may be selected for regulated fields such as healthcare, finance, education, or government services. A lower-security embodiment may use signatures and hashes, while a higher-security embodiment may include cryptographic proofs and hardware attestation.

These embodiments support privacy and compliance while preserving the same terminal record fabric. The proof type can vary by policy, but the verifier still consumes endpoint reference, time window, nonce, evidence commitment, proof result, and receipt status.

### Hardware Attestation Integration Boundaries

Optional hardware attestation may strengthen terminal trust without becoming mandatory for all embodiments. A software-only terminal can use domain keypairs, time signatures, behavior-time proofs, nonces, and lifecycle states. A high-security terminal can additionally use PUF fingerprints, secure enclaves, measured boot, root keys, and remote attestation.

A hardware-attestation record may include terminal identifier, measurement hash, firmware version, policy version, nonce, time window, root-key certificate reference, proof reference, and attestation signature. A verifier may treat the record as an additional input to SIM-free terminal authentication.

If measured boot fails, the terminal may enter limited, quarantined, or re-provisioning-required state. A communication module may still permit low-risk messages while a wallet module remains suspended. Policy can determine which modules require hardware trust.

A hardware terminal may generate domain-anchored credentials that bind device state, endpoint record, and behavior-time proof. The credential can be presented to a remote verifier, wallet, marketplace, or institutional service. The verifier can accept, deny, or request recovery based on the attestation state.

Keeping hardware attestation optional preserves broad software implementation while creating a fallback for high-value medical, banking, vehicle, ATM, IoT, institutional, and asset-transfer deployments.

### Domain-Talking Index and Relationship State

A domain-talking index may link endpoint records to relationship state. Relationship state can indicate known, trusted, limited, blocked, disputed, institutional, merchant, family, emergency, or governance relationships between endpoints. The relationship state may influence communication routing, payment authorization, and access decisions.

The relationship state may be updated by communication receipts, payment receipts, service receipts, governance receipts, or manual policy actions. For example, repeated successful communications with a merchant domain may increase service confidence, while a disputed payment may reduce wallet trust until corrected.

The domain-talking index may support multiple scopes. A user endpoint may have one relationship state with a healthcare provider, another with a merchant, another with a family endpoint, and another with an institutional gateway. Each scope may have its own access and privacy policy.

Relationship state may prevent phishing. A payment request from a look-alike domain may fail because it lacks an established relationship state, valid credential, expected policy version, or settlement history. The receipt can identify the reason for denial or re-verification.

The index therefore supports a technical trust graph layered on the ReadName terminal endpoints. It does not merely store social relationships; it provides machine-readable state for routing, access, payment, and risk decisions.

### Cross-Domain Conflict Resolution

A synchronization conflict may arise when two domain systems report different lifecycle states, wallet statuses, revocation states, or receipt states for the same endpoint. The synchronization channel may identify the conflict and route it to policy resolution rather than accepting both states silently.

Conflict resolution may use receipt priority, timestamp order, policy version, authority hierarchy, quorum verification, domain category, or manual governance action. The resolution output may include accepted state, rejected state, merged state, pending state, or dispute state.

For example, a financial-domain system may place a wallet endpoint on hold while a communication-domain system still treats the endpoint as active for messages. The terminal access registry can represent this as a module-specific limitation rather than a global identity failure.

A conflict receipt may identify source domain, target domain, conflicting field, prior state, proposed state, resolution rule, result state, evidence commitment, and synchronization reference. The receipt can be audited by affected systems without exposing raw private data.

Conflict resolution makes cross-domain synchronization practical. Without conflict handling, a terminal fabric would be vulnerable to inconsistent state. With conflict receipts, systems can interoperate while preserving accountability and module-specific autonomy.

### Terminal Access Granularity

Terminal access may be controlled at module level, operation level, field level, or output level. Module-level control may enable communication while suspending wallet settlement. Operation-level control may allow receipt retrieval while denying transfer. Field-level control may hide wallet scope while revealing communication status.

An access registry entry may include module_id, operation_type, access_state, role, scope, validity_window, required_proof, dependency_state, policy_version, and receipt_reference. A verifier can check the entry before allowing a route, payment, marketplace action, or governance action.

Access granularity can reduce risk after compromise. If a communication key is compromised, only communication may be suspended. If a payment proof fails, wallet and clearing may be limited while identity verification remains active. If a governance credential is disputed, governance may be blocked without disabling messages.

Granular access states also help institutions. A hospital may grant a patient endpoint access to appointment messages but not billing records. A business may grant an employee endpoint service access but not asset-transfer authority. A marketplace may permit listing view but require stronger proof for licensing.

This registry structure gives a concrete implementation for terminal sovereignty. The endpoint can control multiple functions, but each function remains separately governed by state, proof, policy, and receipt.

### Lifecycle Inheritance and Transfer Operations

Inheritance and transfer may be treated as lifecycle operations rather than uncontrolled account changes. A transfer request may include transferor endpoint, transferee endpoint, authority proof, domain-control proof, time window, nonce, policy version, asset or scope reference, and receipt request.

A verifier may check that the transferor endpoint is active and authorized, the transferee endpoint is eligible, the requested scope is transferable, and no pending dispute or freeze prevents the operation. If approved, a transfer receipt updates endpoint record, lifecycle state, access registry, and synchronization state.

Inheritance may require different proofs, such as a policy-triggering event, institutional authority, governance approval, family-domain rule, or emergency condition. The inherited endpoint may receive limited, pending, or active state depending on policy and risk.

A transfer or inheritance can be scoped. Communication rights may transfer separately from wallet rights. Asset-output authority may transfer separately from identity continuity. This prevents overbroad changes and supports regulated deployments.

Structuring inheritance and transfer as lifecycle events prevents ambiguity. The terminal record maintains a history of prior controller, new controller, scope, proof, policy version, and receipt, which supports audit and dispute resolution.

### Marketplace and Governance Operation Examples

A marketplace operation may begin when a terminal endpoint submits a listing request. The request may include resource reference, endpoint reference, identity anchor, license state, settlement state, trust index, audit readiness, valuation metadata, nonce, and policy version. The marketplace can verify the terminal receipt before listing.

A licensing operation may use terminal receipts as evidence of licensor authority and licensee endpoint status. The licensing package may identify scope, territory, duration, payment reference, revocation condition, evidence commitment, receipt reference, and finality state.

A governance operation may use terminal access registry and lifecycle state to determine whether an endpoint can vote, approve, dispute, recover, delegate, or revoke. Governance receipts can update policy version, access state, or synchronization state.

A dispute operation may be initiated by a terminal, institution, marketplace, wallet, or governance module. The dispute receipt may place an asset listing, transfer, payment, or lifecycle change into frozen or pending state until resolution.

These marketplace and governance examples demonstrate that the terminal infrastructure can serve as a common technical layer for economic and institutional operations while preserving the ReadName endpoint as the controlling state object.

### Audit Trails and Compliance Exports

An audit export may include only receipt references and status fields needed by the auditor. For example, an auditor may receive endpoint reference, operation type, policy version, prior state, new state, proof result, evidence commitment, receipt status, and finality state without receiving private payload or raw biometric data.

A compliance export may be scoped to payment, communication, identity, governance, marketplace, or asset-output operations. A financial auditor may receive payment and clearing receipts. A privacy auditor may receive proof of selective disclosure. A marketplace auditor may receive licensing and transfer receipts.

The system may generate audit snapshots at policy-defined intervals. A snapshot may identify terminal state, access registry state, lifecycle state, risk state, index state, and receipt references at a given time. Snapshots support due diligence and recovery after outages or disputes.

A compliance export can be signed by an endpoint, institution, resolver, ledger, or audit service. The signature can bind export fields to a policy version and time window. An export receipt may then be synchronized across domain systems.

Audit and compliance exports help make the terminal fabric commercially usable. Buyers, licensees, regulators, and institutions can verify the existence of structured technical artifacts rather than relying on narrative claims about user behavior or asset ownership.

### Security Against Phishing and Endpoint Substitution

Endpoint substitution attacks may occur when an attacker tries to replace a recipient, merchant, wallet, or service endpoint with a look-alike reference. The resolver may counter substitution by checking canonical endpoint identifiers, identity anchors, relationship state, policy version, and receipt history.

A phishing attempt may present a visual domain, QR code, link, or platform username. The terminal infrastructure can require the domain-linked credential, endpoint record, behavior-time proof, and lifecycle state to match before communication or payment proceeds. A mismatched display string alone is insufficient.

The route verifier may compare expected merchant domain, payee endpoint, wallet scope, and settlement history. If the requested endpoint does not match prior relationship or policy state, the verifier may deny, warn, quarantine, or request step-up verification.

Endpoint substitution risk may be further reduced by signed metadata locks. A payment request may bind merchant endpoint, amount reference, time window, nonce, policy version, and evidence commitment. Any modification changes the signed package and invalidates the receipt path.

This security model provides a technical advantage over static identifiers. A phone number, QR code, or username can be copied, but the ReadName terminal operation requires coherent endpoint record, proof, nonce, lifecycle, policy, and receipt relationships.

### Operational Monitoring and Diagnostics

Operational monitoring may track route denials, payment holds, invalid nonce attempts, expired requests, duplicate credentials, lifecycle changes, synchronization conflicts, proof failures, and recovery events. Monitoring outputs may be aggregated into terminal reliability and risk indices.

Diagnostics may identify which module produced a failure. A client can distinguish endpoint lookup failure, identity-anchor failure, behavior-time proof failure, SIM-free authentication failure, wallet-clearing failure, access-registry denial, or synchronization conflict. This improves system maintenance and user recovery.

A diagnostic receipt may be produced without exposing private evidence. It may include module name, operation type, reason code, policy version, time window, endpoint reference, and receipt status. Support systems can use the diagnostic receipt to guide remediation.

Operational monitoring can also support capacity management. A domain namespace backbone can monitor endpoint generation rate, route volume, wallet clearing volume, receipt volume, synchronization delays, and conflict rates. These values help scale the resolver and receipt store.

Monitoring and diagnostics are optional implementation features, but they show how the claimed records and receipts can support real production deployment rather than a merely theoretical protocol.

### Deployment Migration Paths

A first migration path begins with a conventional user account system. The platform adds ReadName endpoint records and maps existing accounts to identity anchors. Communication and payment continue through legacy channels until the endpoint resolver and receipt store are activated.

A second migration path begins with a wallet platform. The platform maps wallet addresses to ReadName endpoint records, adds SIM-free terminal authentication, and uses machine-verifiable receipts for settlement. Later, the platform can add communication and access registry functions.

A third migration path begins with a messaging platform. The platform adds domain-linked sender and recipient endpoints, route receipts, and lifecycle states. Later, the same endpoints can add wallet clearing and QR replacement payment handshakes.

A fourth migration path begins with an institutional domain system. The institution maps departments, roles, devices, or services to endpoint records and synchronizes access states across domains. Wallet settlement or asset outputs can be added according to policy.

These migration paths illustrate that the invention need not be deployed all at once. The same endpoint record fabric can be introduced module by module while preserving the technical relationship among identity, terminal, route, payment, lifecycle, receipt, and output states.

### Testing Examples for Enablement

A test for DGE generation may input identity reference, system reference, demand type, time window, and nonce. The expected output is a unique endpoint reference, collision status, lifecycle state, and generation receipt. Collision tests can reuse the same inputs and verify that a conflict or duplicate state is detected.

A test for SIM-free authentication may submit a signed request with domain keypair reference, time signature, behavior-time proof, terminal identifier, nonce, validity window, and lifecycle state. The expected output is approved, denied, quarantined, or re-verification-required with reason code and receipt.

A test for switchless communication may submit sender endpoint, recipient endpoint, behavior context, verification field, nonce, validity window, and payload reference. The expected output is route result and route receipt. The test can verify that no phone number or SIM credential is required as controlling endpoint.

A test for QR replacement payment may submit merchant domain request, user endpoint, signed authorization package, behavior-time proof, wallet scope, and policy version. The expected output is payment authorization record and settlement receipt or denial receipt.

A test for lifecycle control may attempt payment after revocation or message routing after suspension. The expected output is denial, quarantine, or re-verification receipt. These tests demonstrate that the specification provides practical implementation guidance for the claimed modules.

### Detailed Receipt Field Relationships

A machine-verifiable receipt may be linked to a parent endpoint record and a parent operation request. The receipt may identify request hash, canonical request reference, endpoint reference, identity anchor, terminal reference, operation type, module identifier, policy version, time window, proof result, prior state, new state, and status.

The receipt may include references to related records. A payment receipt may reference a SIM-free authentication record, behavior-time proof record, wallet scope, and clearing endpoint. A route receipt may reference communication package, route confidence, recipient lifecycle state, and payload reference.

A receipt may also include visibility rules. Some receipt fields may be public, some may be shared only with counterparties, and some may be available only to auditors or governance modules. This supports privacy while preserving verifiability.

Receipts may be chained. A generation receipt may precede an authentication receipt. An authentication receipt may precede a route receipt. A payment authorization receipt may precede a settlement receipt. A lifecycle receipt may supersede earlier access rights. Chaining allows state reconstruction.

The receipt relationships are central to implementation. They allow external platforms to verify terminal operations without trusting a single screen, username, QR code, or phone number. The machine-verifiable receipt becomes the durable evidence of the terminal operation.

### Final Non-Limiting Statement

No single module described herein is required to be implemented with a particular vendor, programming language, blockchain, database, domain registrar, mobile operating system, telecom network, payment network, or hardware manufacturer. The technical relationships among endpoint records, verification states, lifecycle states, receipts, and outputs define the infrastructure.

Where examples refer to ReadName, BEI-ID, TransferKey, behavior-time proof, or domain-token terminal credential, equivalent references may be used if they perform the corresponding technical role. A visible name may differ from a canonical endpoint identifier, and a token may be replaced by a signed database or certificate record.

Where examples refer to communication, payment, navigation, marketplace, governance, or asset outputs, a deployment may implement one or more of these modules. A partial deployment remains within the architecture when it uses the ReadName endpoint record fabric for the implemented module.

Where examples refer to optional hardware attestation, software-only implementations may use keys, signatures, time windows, nonces, policy versions, and receipts. Hardware attestation strengthens trust for high-security deployments but does not limit the broad endpoint architecture.

The foregoing additional embodiments reinforce that the invention is a domain-resolved terminal infrastructure with concrete technical records, verifiers, state transitions, and receipts. The claims define the scope of protection.

### Communication Carrier-Neutral Transport Examples

The switchless communication module may use carrier-neutral transport. A ReadName route can be carried over Wi-Fi, Ethernet, cellular data, satellite data, local mesh links, browser transport, WebRTC sessions, enterprise networks, or IoT gateways. The transport link moves packets, while the ReadName endpoint record controls identity, route, and receipt state.

When a cellular modem is present, the modem may provide connectivity but the SIM credential is not the controlling communication endpoint. The terminal operation is authenticated by the domain-linked endpoint, nonce, time window, behavior-time proof, lifecycle state, and receipt path. This separation allows a user to change carriers while preserving terminal continuity.

When Wi-Fi or satellite data is present, the same route package can be used. The endpoint resolver does not need to know whether packets moved through a carrier, local network, or satellite link. The resolver checks endpoint fields and terminal proofs rather than relying on carrier-specific identity.

In a mesh or emergency deployment, terminals may temporarily relay route packages. A relay terminal may see routing metadata and receipt status without accessing encrypted private payload. Later synchronization can update route receipts and endpoint state when a wider network connection is restored.

This carrier-neutral architecture is a practical implementation of not requiring a telephone number, SIM credential, or switch code as a controlling endpoint. It preserves compatibility with many transports while moving trust control to the ReadName terminal record.

### Domain Endpoint Canonicalization Rules

A visible ReadName may differ from its canonical endpoint identifier. Canonicalization may lower-case domain fields, normalize unicode display names to a safe representation, remove presentation-only characters, bind category and policy fields, and generate a canonical hash or identifier before verification.

Canonicalization prevents an attacker from using visually similar names, hidden characters, conflicting encodings, or alternate display formats to deceive a user or verifier. The resolver evaluates the canonical endpoint record rather than the raw display string alone.

A canonicalization receipt may record visible reference, canonical reference, policy version, time window, verifier identity, and status. The visible reference may be shown to a user, while the canonical reference controls routing, authentication, clearing, and access decisions.

Different domain systems may have different display rules. A national domain category, financial domain category, or medical domain category may impose stricter canonicalization than a general messaging category. These rules may be policy-versioned and synchronized across domain systems.

Canonicalization supports both usability and security. Users can employ human-readable names while the system maintains a stable machine-readable endpoint record for proof, receipt, lifecycle, and audit operations.

### Endpoint Record Storage and Replication

Endpoint records may be stored in a primary registry and replicated to resolver caches, edge nodes, wallet systems, institutional systems, or audit stores. A replicated record may include expiration and revocation fields so that stale caches can be detected and invalidated.

Replication may use push events, polling, signed synchronization packets, append-only logs, ledger anchors, or database replication. A receiving system may verify signature, policy version, prior state, new state, and receipt reference before accepting an update.

A resolver cache may serve low-risk route lookups quickly while requiring live verification for payment, transfer, revocation, or high-value access operations. Cache policy may depend on module, terminal class, risk state, and transaction value.

If replicated records conflict, the system may use conflict resolution receipts. The conflict receipt can identify source registry, target registry, record version, field conflict, resolution rule, and final state. This prevents silent divergence between domain systems.

Storage and replication details make the endpoint fabric deployable at scale. They also distinguish the system from a simple name lookup because the replicated state includes lifecycle, access, receipt, risk, and clearing relationships.

### Wallet Scope and Separation of Funds

A wallet endpoint may have one or more wallet scopes. A personal scope may authorize small payments. A merchant scope may authorize receipts. An institutional scope may require additional approval. An asset-transfer scope may require licensing or finality checks.

Wallet scope separation allows the same ReadName terminal to support multiple financial contexts without merging them. The communication endpoint can be public while the wallet scope remains private, limited, or visible only to authorized clearing modules.

A wallet scope record may include scope_id, endpoint_reference, permitted unit types, payment limits, clearing endpoint, settlement policy, required proof, risk state, and receipt reference. A clearing module can use the scope record before authorizing payment.

If a risk event occurs in one scope, the lifecycle controller can limit that scope without revoking the entire terminal. For example, merchant settlement may be held while communication and identity remain active. This supports continuity and proportional risk control.

Scope separation is useful for individuals, families, enterprises, marketplaces, and institutions. A single ReadName terminal can carry multiple scoped wallet authorities while preserving machine-verifiable receipts for each value operation.

### Service Discovery and Marketplace Resolution

The endpoint resolver may support service discovery. A request can specify a service category, domain context, time window, identity anchor, access state, and policy version. The resolver can return a service endpoint, marketplace listing, denial, re-verification request, or alternative route.

A marketplace resolution may differ from a payment resolution. A user may view a marketplace listing without authorizing a wallet operation. If the user proceeds to license or purchase, the wallet scope, behavior-time proof, and clearing endpoint can be verified separately.

Service endpoints may include healthcare services, education services, professional services, merchant services, governance services, emergency services, IoT services, and audit services. Each service category may require different proof, access, and receipt state.

A marketplace receipt may include listing identifier, endpoint reference, service category, access state, license state, audit state, index state, policy version, and receipt reference. The receipt can be used by valuation and asset-output modules.

This service discovery architecture extends the terminal endpoint beyond communication. A ReadName can identify a person, device, institution, or service while maintaining separate route, wallet, access, and asset-output states.

### Governance and Policy Version Management

Policy version management may determine which proof types, access states, route conditions, payment limits, lifecycle transitions, and receipt fields are required for an operation. A policy version may be global, domain-specific, module-specific, institution-specific, or endpoint-specific.

A policy update may require governance approval, institutional signature, quorum verification, owner authorization, or automated risk condition. The update may generate a policy receipt identifying prior version, new version, authority, scope, effective window, and affected modules.

During a transition, two policy versions may coexist. Operations initiated under an old policy may complete according to that policy, while new operations use the new policy. Receipts can identify which version governed each operation.

If a terminal attempts an operation under an obsolete policy, the verifier may deny, migrate, or request re-signing under the current policy. This prevents replay of old policy permissions and supports regulatory changes.

Policy version management provides a technical control plane for the terminal infrastructure. It allows rules to evolve without changing the underlying endpoint record relationship.

### Recovery From Lost Device or Key Compromise

If a terminal device is lost, the owner or authorized controller may initiate recovery. The recovery request may include identity anchor, recovery credential, alternate endpoint, time window, nonce, policy version, and evidence commitment. The system may place the old terminal reference into limited or revoked state.

If a key is compromised, the key may be rotated while preserving the endpoint identity. The key rotation receipt may identify compromised key reference, new key reference, authorized controller, policy version, time window, and modules affected. Some modules may remain suspended until re-verification.

Recovery may use multiple channels. A user may confirm through a trusted domain, institutional endpoint, hardware-attested terminal, recovery guardian, prior receipt, or governance process. The required channels may depend on wallet scope and risk state.

A recovered endpoint may initially enter limited or re-verification-required state. High-value operations such as asset transfer or large payments may remain disabled until additional proof is supplied. Low-risk communication may be restored earlier.

Device and key recovery are essential for practical deployment. They allow a ReadName terminal to be durable without making it impossible to recover from ordinary hardware loss or compromise.

### Emergency and Offline Operation

In emergency or offline operation, a terminal may use cached endpoint records, cached policy, offline trust vault records, and local receipts. The terminal can perform limited operations according to offline policy until synchronization is restored.

An offline communication operation may generate a provisional route receipt. An offline medical or emergency service operation may generate a provisional access receipt. An offline payment operation may be limited by value threshold, wallet scope, or risk policy.

When connectivity returns, the terminal may synchronize provisional receipts with the domain system. The synchronization module may accept, reject, reconcile, or dispute provisional states according to policy version, timestamp, nonce, and receipt priority.

Offline operation can be scoped to emergency responders, medical devices, field terminals, vehicles, family groups, or institutional clusters. The scope may define which modules remain available and which require online re-verification.

This capability makes the terminal infrastructure useful in degraded networks while preserving accountability. Offline operations are not invisible; they produce receipts and later synchronization records.

### Regulated Identity and Payment Boundaries

The terminal infrastructure may be used with regulated identity and payment systems without replacing legal compliance requirements. A regulator or institution may require additional KYC, KYB, audit, sanctions, payment limit, or data-retention policies before wallet or clearing modules are enabled.

Compliance requirements may be represented as policy fields and access states. A terminal can be active for communication while pending compliance for payment. A merchant endpoint can be permitted for small transactions but require additional verification for higher-value settlement.

A compliance receipt may identify verification provider, policy version, terminal scope, effective window, and status without disclosing all underlying private evidence. The receipt can be synchronized to wallet, marketplace, or audit modules.

If compliance status changes, the lifecycle controller may update access state, wallet scope, or marketplace status. Revocation can be scoped to regulated modules without disabling unrelated communication or identity functions.

This boundary helps implement the invention in real commercial environments. It clarifies that the technical endpoint infrastructure can cooperate with legal and institutional requirements while preserving its terminal record architecture.

### Reference Numeral Support and Figure Mapping

The reference numerals in the drawings identify representative modules and data objects. The overall infrastructure 100 includes generation, verification, routing, authentication, wallet clearing, access, receipt, lifecycle, and index modules. Each drawing supports a portion of the claimed endpoint fabric.

The Dynamic Domain Generation Engine corresponds to generation and collision handling. The endpoint record figure corresponds to fields used by system, method, and computer-readable medium claims. The resolver figure corresponds to mapping operations across communication, navigation, payment, access, and receipt outputs.

The switchless communication and SIM-free authentication figures support route and authentication operations that do not require phone number, SIM credential, or switch code as controlling endpoint. The QR replacement and wallet-clearing figures support payment and settlement embodiments.

The lifecycle, synchronization, mapping, access registry, proof commitment, hardware attestation, metadata lock, risk/finality, asset output, and lifecycle figures support fallback and dependent claim features. They also provide implementation guidance for state transitions and receipts.

The figures are schematic and do not require a fixed physical arrangement. A module shown as a box may be implemented as software, firmware, hardware, service, API, database logic, or secure process. The significance lies in the data flow, verification relationship, and output state.

### Claim-Centered Implementation Summary

In a system implementation, the claim elements may be mapped to services. A namespace service supports the domain backbone. A generation service supports DGE. A registry service stores endpoint records. A resolver service maps references. A communication service routes messages. An authentication service verifies SIM-free requests. A wallet service clears settlement. An access service controls modules. A receipt service records outputs.

In a method implementation, the processor receives fields, generates or resolves the endpoint, binds the identity anchor, retrieves the endpoint record, authenticates the terminal, verifies behavior-time context, routes or authorizes a request, updates state, generates a receipt, and outputs synchronization or index state.

In a computer-readable-medium implementation, the instructions may be distributed across client and server. A client signs operations and creates proof references. A server resolves endpoint records and returns receipts. A wallet or clearing endpoint authorizes settlement. An index service updates route, trust, payment, and asset states.

These implementations show that the three independent claim categories are consistent. The system claim defines the modules, the method claim defines the operational sequence, and the computer-readable medium claim protects executable instructions for the same terminal endpoint fabric.

This claim-centered implementation summary is provided to clarify how a person of ordinary skill can build the invention from the disclosed modules, fields, state transitions, and receipts.

### Commercially Relevant Non-Limiting Use Cases

A secure communications provider may use ReadName endpoints as phone-number-independent communication addresses. The provider can route messages and sessions using route packages and receipts while maintaining optional compatibility with email, phone, or platform accounts.

A wallet provider may use ReadName endpoints as human-readable payment endpoints that include behavior-time proof and settlement receipt. The provider can reduce dependence on static QR images and support merchant-domain verification.

A medical platform may use ReadName endpoints for patient, clinician, device, and institution terminals. The platform can use privacy-preserving proof commitments and optional hardware attestation while generating audit receipts for access and communication.

An IoT platform may use endpoint records for sensors and devices. Devices can authenticate without SIM credentials as controlling identity and can generate time-windowed status receipts. Risk isolation can quarantine compromised devices without removing the entire domain system.

An intellectual-property or asset platform may use terminal receipts to support licensing, transfer, marketplace listing, audit, valuation, and index outputs. The asset platform does not need to control the user private evidence if it can verify endpoint receipts.

### End of Specification

The described embodiments provide sufficient detail for implementation while allowing different deployment choices. A person of ordinary skill may implement the invention using existing processors, databases, APIs, key-management systems, networks, ledgers, secure modules, and application interfaces.

The scope of the invention is not limited to the particular order of examples. Operations may be reordered, combined, distributed, or separated when technically compatible. The endpoint record and receipt relationships may remain the same across different deployment architectures.

Features described with one embodiment may be combined with features of another embodiment unless the combination is technically inconsistent. For example, a QR replacement payment deployment may also use hardware attestation, cross-domain synchronization, and asset-output records.

The drawings, definitions, data structures, operating sequences, and implementation examples are intended to support the claims and to demonstrate technical operation. They are not intended as business advice, internal drafting notes, or valuation commentary.

The claims that follow define the metes and bounds of the requested patent protection.

### Endpoint Governance and Delegation Details

A terminal controller may delegate scoped authority to another endpoint. The delegated authority may be limited by module, time window, operation type, wallet limit, service category, territory, or policy version. A delegation record may identify delegator endpoint, delegate endpoint, scope, validity window, revocation condition, evidence commitment, and receipt reference.

Delegation does not require transfer of the primary identity anchor. For example, a family member may be delegated emergency communication authority, a clinic may be delegated medical appointment access, or an employee may be delegated marketplace listing authority while payment authority remains restricted.

A verifier may check delegation before allowing the requested operation. If the delegation is expired, revoked, out of scope, or inconsistent with terminal lifecycle state, the verifier may deny the operation and issue a delegation denial receipt.

Delegation receipts may be synchronized across domain systems. When a delegation is revoked in one system, communication, wallet, governance, or marketplace modules in other systems may receive a synchronization update and prevent stale delegated authority from being used.

This delegation structure supports practical control of multi-user and institutional terminals while preserving the endpoint record as the root technical state object.

### Terminal Class and Policy Profiles

A terminal may have a terminal class, such as personal terminal, merchant terminal, institutional terminal, device terminal, medical terminal, vehicle terminal, emergency terminal, wallet terminal, marketplace terminal, or governance terminal. The terminal class may influence proof requirements and access policies.

A personal terminal may require liveness proof and domain key signature for payments. A merchant terminal may require business credential and settlement policy. A medical terminal may require privacy-preserving proof and institutional authorization. An IoT terminal may require device certificate and time-windowed status proof.

Policy profiles may define required fields, allowed modules, maximum settlement amounts, cache duration, proof strength, recovery workflow, and synchronization frequency. Profiles may be versioned and referenced in endpoint records and receipts.

Terminal class does not limit the invention to a fixed category. It provides a technical configuration mechanism that allows the same endpoint fabric to support many types of users, devices, institutions, and services.

Using terminal class and policy profiles improves enablement because a deployment can select concrete rules for each terminal type rather than treating all endpoints identically.

### Data Minimization and Consent-Aware Operation

A terminal operation may be configured to minimize disclosed data. The requesting module may declare the minimum data fields needed for a particular operation, and the access registry may determine whether those fields can be disclosed or whether a proof result is sufficient.

For a communication route, the recipient may need only sender endpoint, proof status, route context, and receipt status. For a payment clearing operation, the clearing endpoint may need wallet scope, value reference, settlement policy, proof status, and receipt reference. For audit, a verifier may receive receipt references without raw payload.

A consent-aware embodiment may record user approval, institutional approval, delegated approval, or policy approval for disclosure of particular fields. Consent may be represented as a receipt field, access state, or proof reference. It may expire or be revoked according to lifecycle policy.

Data minimization supports privacy and reduces attack surface. The endpoint record can coordinate operations without exposing all identity, behavior, wallet, communication, or biometric data to every participant.

This embodiment reinforces that the terminal infrastructure is not a surveillance system. It can use commitments, proofs, scoped disclosures, and receipts to provide verification while limiting raw data flow.

### Proof Strength Escalation and Step-Up Verification

The verifier may select proof strength based on operation risk. A low-risk message may require endpoint status and nonce. A sensitive message may require behavior-time proof. A payment may require wallet scope and liveness. A transfer may require lifecycle authority, policy version, and additional approval.

Step-up verification may occur when route confidence is low, terminal reliability decreases, behavior pattern changes, payment value exceeds threshold, endpoint relationship is new, nonce anomalies occur, or a risk state is detected. Step-up may require new signature, additional behavior proof, hardware attestation, or governance approval.

A step-up verification receipt may include trigger reason, required proof, provided proof, prior state, new state, policy version, and status. If step-up succeeds, the operation proceeds. If it fails, the operation may be denied, delayed, quarantined, or limited.

Proof strength escalation allows a deployment to balance usability and security. It avoids requiring maximum proof for every low-risk operation while preserving strong proof for sensitive communications, payments, transfers, and asset outputs.

This adaptive proof workflow provides technical specificity for behavior-time proof and access registry decisions and supports implementation in web, mobile, wallet, IoT, and institutional systems.

### Terminal-to-Terminal Trust Establishment

Two terminals may establish mutual trust before communication, payment, or service exchange. A first terminal may present endpoint record, identity anchor, policy version, lifecycle state, and proof status. A second terminal may verify those fields and return its own corresponding trust package.

Mutual trust establishment may produce a session receipt. The receipt may identify both endpoints, proof results, time window, nonce values, policy version, relationship state, permitted modules, and expiration. The receipt can be reused within the session scope.

Terminal-to-terminal trust can be direct or mediated by an endpoint resolver, institutional gateway, wallet clearing endpoint, or governance service. A direct embodiment may be useful for peer communication or local mesh. A mediated embodiment may be useful for payment or regulated access.

If either terminal changes lifecycle state during a session, the session receipt may be invalidated or marked re-verification-required. This prevents stale sessions from remaining valid after revocation, suspension, or risk isolation.

Mutual trust establishment extends the terminal fabric beyond one-sided authentication. It allows both sides of a communication or value operation to verify endpoint state and proof status before exchanging sensitive information or value.

### Index Update Provenance

Index updates may include provenance records. A trust index update may reference communication receipts, payment receipts, lifecycle receipts, risk receipts, or governance receipts that caused the change. A payment eligibility index may reference clearing receipts and wallet scope records.

An index provenance record may include index_type, prior_index_value, new_index_value, contributing_receipts, policy_version, time_window, weighting_reference, and status. The contributing receipts may be hashed or summarized to preserve privacy.

Index provenance supports auditability. A user or institution can ask why a terminal reliability index changed and receive a machine-readable explanation based on receipts rather than an unexplained platform score.

Index provenance may also support correction. If a contributing receipt is disputed or corrected, the index engine can recompute or annotate the index update. The correction path may generate a new provenance receipt.

This structure makes index outputs technical and verifiable. The index is not a mere reputation label; it is tied to endpoint records, terminal states, receipts, and policy versions.

### Receipt-Based Due Diligence for Asset Packages

An asset package may be evaluated using receipt-based due diligence. The due diligence process may collect terminal receipts, license receipts, transfer receipts, payment receipts, audit receipts, lifecycle receipts, and index provenance records associated with a resource reference.

A due diligence output may identify whether an asset is active, licensed, transferred, disputed, cleared, audited, or final. It may also identify missing receipts, conflicting lifecycle states, expired policies, unresolved disputes, or risk isolation events.

The due diligence output may be shared with a marketplace, investor, licensee, auditor, institution, or governance system. Sensitive underlying evidence can remain hidden when receipts and commitments provide sufficient verification status.

Receipt-based due diligence is interoperable with the terminal infrastructure because the same endpoint record controls identity, communication, wallet, clearing, access, and asset-output states. This provides continuity from original terminal event to asset package review.

This embodiment shows how the terminal infrastructure can support commercialization and transfer of digital or physical resources without relying on manual document assertions alone.

### Final Clarifying Embodiments

The described infrastructure can be practiced without requiring all modules to be active in every deployment. A communication deployment may omit wallet settlement. A payment deployment may omit marketplace listing. A medical deployment may require stronger privacy proof. An institutional deployment may require governance approval.

When modules are omitted, inactive fields may be null, disabled, unassigned, hidden, or replaced by supporting references. The remaining active fields continue to operate through the endpoint record, verifier, lifecycle state, and receipt fabric.

The broad terminal architecture should be distinguished from any one branded implementation. ReadName, BEI-ID, TransferKey, and similar names may identify exemplary embodiments, but equivalent names and field labels can implement the same technical relationships.

The system may be implemented by one entity or by several interoperating entities. A registrar may operate namespace functions, a wallet may operate clearing, an enterprise may operate access registry, and an audit service may validate receipts. Interoperability is achieved through structured records and policy versions.

The claims should be understood in view of this specification as covering the described technical relationships among domain-resolved endpoint generation, endpoint records, switchless routing, SIM-free authentication, behavior-time proof, clearing, lifecycle, receipt, synchronization, and asset outputs.

### Additional Data Object Schemas

In an additional data schema, a ReadName terminal endpoint object may contain a display_name field, canonical_endpoint field, identity_anchor field, terminal_class field, lifecycle_state field, active_modules field, policy_version field, synchronization_state field, and receipt_reference field. The object can be serialized for API use or stored in a registry.

In an additional data schema, a route verification object may contain sender_endpoint, recipient_endpoint, message_context, requested_transport, behavior_proof_reference, route_confidence, nonce, validity_window, route_policy, and route_receipt. The route verification object may be short-lived and tied to a single route operation.

In an additional data schema, a wallet clearing object may contain payer_endpoint, payee_endpoint, merchant_domain, clearing_endpoint, value_reference, wallet_scope, payment_policy, behavior_proof_reference, settlement_state, and settlement_receipt. The object may support clearing without exposing raw wallet secrets.

In an additional data schema, a lifecycle transition object may contain endpoint_reference, prior_state, requested_state, authority_reference, triggering_event, proof_reference, reason_code, policy_version, validity_window, and lifecycle_receipt. The object permits structured changes to terminal authority.

These schemas are exemplary and may be implemented as JSON, XML, database rows, signed messages, certificates, ledger events, or other structured records. Their purpose is to show implementation-level relationships among fields already described in the terminal infrastructure.

### Developer Integration Workflow

A developer integration may begin by calling a ReadName initialization API to create an endpoint record. The API returns canonical endpoint identifier, identity anchor reference, lifecycle state, policy version, and generation receipt. The client stores the endpoint reference for later operations.

The developer may then integrate the authorization SDK. The SDK signs operations with endpoint-specific keys and includes nonce, time window, policy version, and operation type. The SDK may also request behavior-time proof from a local module or trusted service.

For communication integration, the developer calls a route API with sender endpoint, recipient endpoint, payload reference, behavior context, nonce, and validity window. The route API returns delivery status and route receipt. For payment integration, the developer calls a clearing API with payer endpoint, payee endpoint, value reference, proof reference, and wallet scope.

For lifecycle integration, the developer calls update, revoke, recover, or transfer APIs. Each call produces a lifecycle receipt and updates synchronization state. The developer can retrieve current endpoint state before permitting user interface actions.

This workflow demonstrates how the invention can be implemented by ordinary developers without requiring access to hidden internal notes. The system is defined by APIs, fields, state transitions, and receipts that can be tested and audited.

### Privacy-Preserving Audit Workflow

In a privacy-preserving audit workflow, an auditor requests receipts rather than raw private evidence. The system returns receipt identifiers, endpoint references, operation types, policy versions, proof results, evidence commitments, prior states, new states, and signature references according to audit scope.

If the auditor needs stronger verification, the terminal or institution may reveal selective evidence or cryptographic proof that corresponds to the evidence commitment. The auditor can verify that the commitment matches without receiving unrelated private data.

A payment audit may show settlement status, wallet scope, clearing endpoint, and receipt chain. A communication audit may show route status, endpoint state, and delivery receipt. An access audit may show module state and lifecycle transitions.

An audit workflow may be role-based. A marketplace auditor, healthcare auditor, financial auditor, governance auditor, and user-facing transparency tool may each receive different fields from the same receipt fabric. Access is controlled by policy and terminal state.

This workflow supports regulatory and commercial review while preserving privacy. It is particularly useful where terminal operations produce value, licensing, transfer, or governance consequences.

### Implementation of Bounded Correction Windows

A bounded correction window may be defined by time window, policy version, operation type, endpoint class, value amount, asset type, or receipt state. Within the window, authorized parties may dispute, freeze, annotate, reissue, or correct a record according to policy.

After the correction window closes, the finality interface may mark the operation final, closed, settled, licensed, transferred, indexed, or expired. Unauthorized reopening after finality may be rejected. A later dispute may require a new corrective record rather than modification of the final record.

For communication, a correction may annotate a route receipt or revoke a payload reference. For payment, a correction may hold, reverse, or reissue settlement according to clearing policy. For asset outputs, a correction may suspend listing, update license status, or add audit annotation.

The bounded correction interface may preserve the audit trail. Prior records remain referenced, and corrected records include prior state, new state, correction reason, authority reference, and evidence commitment. This prevents silent deletion of disputed terminal operations.

Correction windows provide a technical compromise between immediate irreversibility and uncontrolled change. They allow practical error handling while preventing duplicate minting, duplicate clearing, duplicate licensing, duplicate transfer, and unauthorized reopening.

### Further Examples of No-SIM and No-Phone Control

A first no-SIM example is a web terminal using Wi-Fi and a browser. The terminal signs a message with a domain keypair, provides a behavior-time proof, and receives a route receipt. No telephone number or SIM credential controls the operation.

A second no-SIM example is an IoT sensor using a local gateway. The sensor submits time-windowed status data and endpoint signature to the gateway. The gateway relays the packet, but the terminal endpoint record controls authentication and receipt.

A third no-phone example is a merchant payment terminal. The merchant domain presents a payment request. The user endpoint signs authorization through the SDK and receives a settlement receipt. A phone number may be absent or merely optional display data.

A fourth example is an emergency field device using satellite data. The satellite link provides transport, but route authority is based on domain endpoint, lifecycle state, proof reference, and emergency policy receipt.

These examples clarify that the invention does not deny the use of communication networks. It changes the controlling identity and routing object from a carrier or phone-number credential to the ReadName terminal endpoint record.

### Additional Route and Payment Edge Cases

If a recipient endpoint is active but the communication module is limited, the route verifier may return a limited-route receipt rather than a general denial. The limited receipt may permit a text notice but deny voice, video, attachment, wallet confirmation, or marketplace signal according to access state.

If a merchant endpoint is active but its clearing endpoint is suspended, the payment module may permit a quote or invoice request while denying settlement. The denial or hold receipt identifies clearing state as the reason, allowing the merchant to recover without changing its communication endpoint.

If a behavior-time proof is valid for communication but not for payment, the terminal may route a message and require step-up verification for the payment. The same endpoint can therefore support different proof strengths for different operation classes.

If a synchronization packet reports a revoked endpoint after a route was queued but before delivery, the system may quarantine the queued message and issue an updated route receipt. This prevents stale queued operations from bypassing lifecycle changes.

If an index update fails while a payment settlement succeeds, the settlement receipt can remain valid and the index update can be retried. The system separates transaction finality from auxiliary index propagation while preserving receipt linkage.

### Additional Security and Audit Interactions

A verifier may use receipt chains to identify anomalous patterns. A sequence of valid messages followed by repeated invalid payment attempts may trigger wallet module quarantine without disabling communication. A sequence of failed route attempts to many recipients may trigger communication rate limitation.

An audit module may verify that each high-value operation has a corresponding terminal authentication record, behavior-time proof reference, lifecycle state, policy version, and receipt. Missing links may cause audit warning, listing suspension, or re-verification request.

In a distributed deployment, different modules may sign their own receipts. A resolver may sign route receipts, a wallet module may sign settlement receipts, an access registry may sign access receipts, and a synchronization service may sign state propagation receipts. A composite audit can verify each signature in its scope.

A receipt may include a redaction or privacy flag. The flag can indicate that raw evidence is withheld but evidence commitment or proof result is available. This allows auditors to distinguish missing data from intentionally privacy-preserved data.

These interactions show that the claimed receipt fabric is not merely a log. It becomes an operational control mechanism for security, compliance, reliability, and cross-platform interoperability.

### Additional Closing Implementation Guidance

A person implementing the invention may begin with the endpoint record and receipt store because those structures connect all modules. Once the endpoint record exists, communication, authentication, payment, lifecycle, and index functions can be added as separate services.

The implementation should treat phone numbers, SIM credentials, QR identifiers, GPS coordinates, platform usernames, and wallet addresses as optional supporting references unless a deployment policy intentionally promotes one of them. The controlling state for the claimed terminal operations remains the domain-resolved endpoint record and its proof and receipt fields.

Implementation should avoid storing unnecessary raw personal data in shared records. Evidence commitments, proof results, selective disclosures, and encrypted references provide sufficient state for many operations while preserving privacy.

Implementation should issue receipts for both successful and failed operations. Denial, hold, quarantine, re-verification, revocation, and recovery receipts are as important as successful route and settlement receipts because they define state transitions and support audit.

These additional implementation details further support the claimed invention as a concrete technical infrastructure for domain-resolved terminal operations across communication, authentication, payment, access, lifecycle, receipt, and asset-output systems.

The invention claimed is:

1. A domain-resolved ReadName Token Terminal infrastructure system, comprising: a domain namespace backbone comprising a plurality of domain-based systems configured to support terminal endpoint references; a Dynamic Domain Generation Engine configured to generate a ReadName terminal endpoint from input fields comprising an identity reference, a system reference, a demand or context type, a time-window value, and a nonce or random seed; a ReadName Token Terminal endpoint record binding the ReadName terminal endpoint to an identity anchor, a terminal reference, a communication endpoint, a wallet endpoint, a clearing endpoint, an access registry reference, a policy version, a lifecycle state, and a receipt reference; an endpoint resolver configured to map a domain-linked reference, terminal-linked reference, wallet reference, service endpoint, marketplace endpoint, or governance endpoint to at least one communication, navigation, payment, clearing, terminal-access, receipt, or index operation; a switchless communication routing module configured to route a message or session using domain-linked sender and recipient references, a behavioral context field, a verification field, a nonce, and a validity window without requiring a telephone number, SIM credential, or switch code as a controlling endpoint; a SIM-free terminal authentication module configured to validate a terminal operation using a domain keypair, time signature, terminal identifier, behavior-time proof, nonce, validity window, and policy version; a behavior-time routing module configured to resolve a communication, navigation, payment, or access request using at least one of behavior density, time continuity, interaction diversity, route confidence, relationship state, or domain context; a wallet or clearing endpoint module configured to authorize a payment or settlement operation using a domain-linked credential and to generate a machine-verifiable receipt; a terminal access registry configured to enable, limit, suspend, revoke, or require re-verification of at least one terminal module according to an access state; and an output module configured to update at least one credential state, terminal state, transaction state, revocation state, receipt state, or index state.

2. The system of claim 1, wherein the plurality of domain-based systems includes one or more national, regional, industry, professional, temporal, cultural, alphabetical, numerical, symbolic, service, financial, medical, educational, governance, or marketplace domain categories.

3. The system of claim 1, wherein the Dynamic Domain Generation Engine generates the ReadName terminal endpoint using a cryptographic hash, deterministic mapping, policy-controlled mapping, or collision-resistant generation operation over at least the identity reference, system reference, demand or context type, time-window value, and nonce or random seed.

4. The system of claim 1, wherein the ReadName Token Terminal endpoint record further comprises a domain reference, a communication route status, a wallet scope, a clearing status, a revocation state, an evidence commitment, and a validity window.

5. The system of claim 1, wherein the switchless communication routing module routes at least one text, voice, video, service, credential, wallet, marketplace, governance, or terminal-access signal without using a phone number, SIM credential, switch code, QR identifier, or platform username as the controlling routing endpoint.

6. The system of claim 1, wherein the SIM-free terminal authentication module validates the terminal operation by checking a domain keypair signature, a time signature, a terminal identifier, a behavior-time proof reference, a nonce, a validity window, a policy version, and a lifecycle state.

7. The system of claim 1, further comprising an authorization software development kit configured to sign or verify at least one identity, communication, payment, navigation, minting, terminal-access, lifecycle, revocation, settlement, or receipt-retrieval operation.

8. The system of claim 1, wherein the behavior-time routing module resolves a route or endpoint using a behavior density value, time continuity value, interaction diversity value, route confidence value, domain-node context, relationship state, trust value, relevance value, or policy state, and wherein GPS data is not required as the sole controlling route source.

9. The system of claim 1, further comprising a cross-domain synchronization or mapping module configured to synchronize or map at least one identity state, credential state, terminal state, transaction state, revocation state, receipt state, access state, risk state, or index state across at least two domain-based systems.

10. A computer-implemented method for generating, authenticating, routing, settling, and controlling a domain-resolved ReadName Token Terminal, comprising: receiving, by one or more processors, an identity reference, terminal reference, demand or context type, time-window value, nonce, and domain context; generating, by a Dynamic Domain Generation Engine, a ReadName terminal endpoint; binding the ReadName terminal endpoint to an identity anchor and a terminal endpoint record; generating or retrieving an endpoint record comprising at least a communication endpoint, wallet endpoint, clearing endpoint, access registry reference, lifecycle state, and receipt reference; authenticating a terminal operation using a SIM-free terminal authentication record comprising a domain keypair reference, time signature, behavior-time proof, terminal identifier, nonce, validity window, and policy version; verifying a behavior-time routing context associated with a communication, navigation, payment, settlement, terminal access, marketplace, governance, or lifecycle request; routing the request or authorizing a payment or settlement according to the verified behavior-time routing context and the endpoint record; updating at least one lifecycle state, risk state, access state, transaction state, revocation state, receipt state, or index state; generating a machine-verifiable receipt for the operation; and outputting an index update, feedback record, synchronization record, or interoperable asset-output record.

11. The method of claim 10, wherein a payment request is authorized using a behavior-time proof and domain-linked credential instead of, or in addition to, a static QR identifier.

12. The method of claim 10, further comprising binding a terminal event to a time-domain reference to generate at least one time-asset record, eligibility record, service credit record, settlement record, audit record, or receipt.

13. The method of claim 10, further comprising assigning to the ReadName terminal endpoint or identity anchor a lifecycle state selected from initialized, pending, active, limited, suspended, revoked, expired, inherited, transferred, recovered, disputed, quarantined, or re-verification-required.

14. The method of claim 10, further comprising generating a risk isolation signal in response to detecting an abnormal route, invalid nonce, duplicate credential, replay attempt, terminal compromise, payment conflict, policy conflict, expired validity window, or unauthorized transfer.

15. The method of claim 10, wherein the machine-verifiable receipt or event metadata lock includes an event type, endpoint reference, identity anchor, terminal reference, policy version, prior state, new state, verification result, evidence commitment, time-window field, and receipt status.

16. The method of claim 10, further comprising applying a bounded-correction or finality interface that supports at least one dispute, freeze, mask, annotation, callback, clawback, rollback, reissue, invalidate, restrict, finality, duplicate-prevention, or unauthorized-reopening-prevention state.

17. A non-transitory computer-readable medium storing instructions that, when executed by one or more processors, cause the one or more processors to perform operations comprising: generating a ReadName terminal endpoint from an identity reference, system reference, demand or context type, time-window value, and nonce or random seed; resolving the ReadName terminal endpoint to an endpoint record comprising an identity anchor, terminal reference, communication endpoint, wallet endpoint, clearing endpoint, access registry reference, lifecycle state, and receipt reference; authenticating a terminal operation without requiring a SIM credential as the controlling identity source; verifying a behavior-time proof, nonce, validity window, and policy version associated with a communication, navigation, payment, clearing, terminal-access, lifecycle, marketplace, governance, or receipt request; routing or authorizing the request using a domain-linked endpoint reference; generating a machine-verifiable receipt; and updating a credential state, terminal state, transaction state, revocation state, access state, receipt state, or index state.

18. The non-transitory computer-readable medium of claim 17, wherein the operations further comprise receiving or verifying an optional hardware-attestation record generated using a physical unclonable function, trusted execution environment, secure enclave, measured boot verification, root-key derivation, secure storage, or remote attestation report.

19. The non-transitory computer-readable medium of claim 17, wherein the operations further comprise generating or updating at least one license package, transfer package, marketplace listing, audit record, asset package, valuation metadata, trust index, time index, route index, payment eligibility index, terminal reliability index, or asset valuation index.

20. The non-transitory computer-readable medium of claim 17, wherein the operations further comprise exposing an application programming interface for at least one of ReadName initialization, endpoint lookup, SIM-free authentication, message routing, payment clearing, navigation resolution, terminal access, lifecycle update, revocation, receipt retrieval, risk isolation, index update, marketplace listing, licensing, transfer, or audit verification.
